(19) United States
(12) Patent Application Publication
(10) Pub. No.: US 2026/0149686 A1
(43) Pub. Date: May 28, 2026

(54) CHANNEL SELECTION AND PERSONALIZATION BASED ON MACHINE LEARNING MODELS

(71) Applicant: Twilio Inc., San Fancisco, CA (US)

(72) Inventors: Benjamin Croes, Oakland, CA (US); Samarpan Das, Bangalore (IN); Anurag Dodeja, Danville, CA (US); Alireza Farasat, Danville, CA (US); Xin Gu, San Carlos, CA (US); Nicolaus Haderlie, Fort Collins, CO (US); Peter Janovsky, Pleasanton, CA (US); David Moses Lee, Seattle, WA (US); Stanley Carl Lemon, Indianapolis, IN (US); Michael Piccirili, San Francisco, CA (US); Igor Pletnjov, Estonia (EE); Anurag Tiwari, Bengaluru (IN)

(21) Appl. No.: 19/401,289

(22) Filed: Nov. 25, 2025

Related U.S. Application Data
(60) Provisional application No. 63/724,734, filed on Nov. 25, 2024.

(51) Int. Cl. H04L 51/56; H04L 51/214

(52) U.S. Cl. CPC H04L 51/56; H04L 51/214

(57) ABSTRACT

Systems and methods for channel selection and personalization based on machine learning models are described herein. The system receives a request to transmit a message to a recipient and identifies destination endpoint identifiers associated with the recipient. The system retrieves historical messaging data from a data store and extracts features comprising message volume metrics and channel-specific delivery metrics. The system associates the recipient with a cluster of recipients based on the extracted features and retrieves channel preference rankings for the cluster. The system selects a communication channel and destination endpoint identifier based on the channel preference rankings, then transmits the message via the selected channel. The system groups recipients based on messaging behavior similarities and derives channel preference rankings from historical delivery success rates and recipient engagement rates within each cluster.

### CROSS REFERENCE TO RELATED APPLICATIONS

This patent application claims priority to U.S. Provisional Patent Application No. 63/724,734 titled “CHANNEL SELECTION AND PERSONALIZATION BASED ON MACHINE LEARNING MODELS” filed on Nov. 25, 2024. The above-referenced application is incorporated herein by reference.

### TECHNICAL FIELD

Aspects and embodiments of the disclosure relate to computer networking, and more specifically, to systems and methods for selecting and personalizing channels based on machine learning models.

### BACKGROUND

Channels can refer to the various communication methods and platforms through which another platform enables interactions between clients and their end users.

### BRIEF DESCRIPTION OF THE DRAWINGS

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding.

FIG. 1A illustrates an example system architecture, in accordance with some embodiments of the disclosure.

FIG. 1B illustrates an example system architecture, in accordance with some embodiments of the disclosure.

FIG. 2 illustrates an example system architecture, in accordance with some embodiments.

FIG. 3 illustrates a time sequence diagram for channel selection and personalization process, in accordance with some embodiments of the disclosure.

FIGS. 4A and 4B show a flow diagram of an example method of channel selection and personalization based on machine learning models, in accordance with some embodiments of the disclosure.

FIG. 5 is a block diagram illustrating an exemplary computer system, in accordance with some embodiments of the disclosure.

### DETAILED DESCRIPTION

A communication services platform, such as a Software as a Service (SaaS) platform, can offer various communication services to users. For example, a SaaS platform can offer messaging service tools that facilitate messaging conversations, e.g., the sending and/or receiving of messages, such as Short Message Service (SMS) messages, Multimedia Messaging Service (MMS) messages, Rich Communication Services (RCS), Rich Business Messaging (RBM), electronic mail (email) messages, and/or instant messaging (IM) messages, to and from devices via various communication channels. A communication channel can refer to a form of communication that uses one or more of a particular protocol, a particular underlying technology or is provided by a particular entity (e.g., third-party entity). Different communication channels can refer to different forms of communication that can use one or more of different communication protocols, different underlying technologies (e.g., SMS vs Internet Protocol (IP)), or are provided by different entities, such as a third-party entity, that offer services, software or hardware (or a combination thereof) through which messages can be exchanged between recipient devices. For instance, the SaaS platform may send a text message (e.g., SMS message) to a recipient device using a communication channel, such as a telecommunications carrier network or send an instant message to a recipient device using an IM communication channel (e.g., using an application programming interface (API) to communicate with the IM communication channel). Examples of channels include SMS, MMS, RCS (including, e.g., RBM), voice calls (via Public Switched Telephone Network (PSTN), cellular, Voice over Internet Protocol (VoIP), or similar), video calls, instant messaging (e.g., WhatsApp, Facebook Messenger), electronic mail, and others.

Organizations and businesses (referred to as “clients” herein) of a SaaS platform may subscribe to one or more communication services that allow the clients to send outbound communications to their end users (referred to as “recipients” herein) via one or more channels. The communication services platform acts as an intermediary that facilitates message delivery from clients to recipients. For example, a retail company (client) may use the platform to send promotional messages to its customers (recipients), or a healthcare provider (client) may use the platform to send appointment reminders to its patients (recipients). The recipients can have personal channel preferences that may not be explicitly provided to the SaaS platform or client. Additionally, in many instances very little may be known about the respective recipient's communication preferences. For example, the recipient may not actively provide preference data indicating which communication channels they prefer for receiving messages. With various available channels for selection, it can be challenging for the platform to determine which channel is appropriate for delivering a particular message from a client to a particular recipient, especially when channel preferences for the recipient are unknown.

Aspects of the disclosure address the above-mentioned and other challenges by providing a system that provides channel selection to select and route communication traffic (e.g., message traffic) through channels based on clustering of recipients based on their messaging behavior patterns and demographic characteristics (e.g., geographic location, age group, industry sector, communication preferences).

A recipient refers to the actual person or entity who receives messages, while a destination endpoint identifier specifies where a message should be delivered, such as a phone number or email address, to reach that recipient. A single recipient may be associated with multiple destination endpoint identifiers across different communication channels. For example, a customer (recipient) of a retail company may have a phone number for SMS messages, an email address for promotional emails, and a WhatsApp number for customer service interactions. Each of these addresses is a separate destination endpoint identifier for the same recipient.

The system can identify the destination endpoint identifiers associated with the recipient by accessing a recipient profile database that stores mappings between recipient identifiers and their associated destination endpoint identifiers. For example, the recipient profile database may store an entry for a customer (recipient) that lists all phone numbers, email addresses, and messaging application identifiers (e.g., WhatsApp numbers, Telegram usernames) registered to that customer. These associations may be established when the recipient registers with the client's service, when the recipient provides contact information across multiple interactions, or when the system infers connections based on shared attributes (such as messages from the same IP address or device identifier). In some embodiments, the client provides the mapping of recipients to destination endpoint identifiers through an API call or configuration data.

Historical messaging data includes stored records of past message deliveries, including individual message delivery information, aggregated delivery statistics, engagement event data, delivery success indicators, failure codes, timestamps, and recipient interaction events across different communication channels. The system processes this historical messaging data to compute quantitative metrics called “features.” Features extracted from historical messaging data can include: a total number of messages received by the destination endpoint identifier during a time period; for each communication channel, a channel-specific message count indicating a number of messages received via that communication channel during the time period; for each communication channel, a channel-specific delivery metric indicating a proportion of messages successfully delivered via that communication channel; and a recipient engagement metric indicating a rate at which the recipient associated with the destination endpoint identifier engaged with received messages. The message volume metric represents the total count of messages received by a destination endpoint identifier, which may be calculated as an aggregate across all communication channels or as channel-specific message counts. In one implementation, a message volume metric for a phone number may include the total number of SMS, MMS, and RCS messages received during the time period, or may be broken down into separate volume metrics for each channel type. For example, to calculate a channel-specific delivery ratio for SMS, the system analyzes historical messaging data associated with the destination endpoint identifier to determine the total number of SMS messages sent to that identifier during the time period and how many were successfully delivered (e.g., did not result in delivery failure error codes), then divides the successful delivery count by the total message count to produce a ratio (e.g., 85 successful deliveries out of 100 messages=0.85 delivery ratio). Recipient engagement refers to various forms of interaction that recipients have with received messages, such as opening or reading the message, clicking on links or buttons within the message, replying to the message, making a purchase or completing a transaction prompted by the message, downloading an application mentioned in the message, or taking other actions requested in the message content. Similarly, to calculate recipient engagement metrics, the system analyzes historical messaging data to identify messages that resulted in engagement actions and divides the count of messages with engagement by the total messages received to produce an engagement rate (e.g., 30 messages with clicks out of 100 messages=0.30 engagement rate or 30%). The system may compute these metrics in real-time by processing individual message data, or may retrieve pre-computed metrics that were calculated from historical message data at an earlier time. In some implementations, not all combinations of destination endpoint identifiers and communication channels will have associated metrics. For example, an email address destination endpoint identifier will typically have feature values for the email channel but null or zero values for SMS or voice channels. The system may represent such absent data as zero values, null values, or may omit those feature dimensions entirely from the feature vector.

When a recipient is associated with multiple destination endpoint identifiers, the system may aggregate the extracted features across the identifiers to generate a unified recipient feature profile. A recipient feature profile is a data structure that represents the aggregated messaging characteristics of a recipient across all of their associated destination endpoint identifiers. For example, the system may calculate aggregate message volume metrics by summing the message counts across all identifiers, compute weighted average delivery ratios across channels based on message volumes, and average engagement rates across identifiers. In one embodiment, the system may weight features from different identifiers based on recency (giving more weight to recently-active identifiers) or based on message volume (giving more weight to identifiers with more historical data). The aggregated recipient feature profile can then be used to assign the recipient to a cluster. In some embodiments, the system may assign each destination endpoint identifier to a cluster independently and associate the recipient with the cluster having the most assigned identifiers, or with the cluster of the identifier having the highest message volume or most recent activity.

A cluster of recipients includes a group of recipients that have been grouped together based on similarities in their messaging behavior and/or other characteristics such as demographic attributes (age, location), geographic patterns, industry sectors, and communication preferences. Each cluster of recipients may include destination endpoint identifiers that exhibit comparable features derived from historical messaging data. The system calculates similarity measures between extracted features and feature representations of a plurality of clusters of recipients to assign destination endpoint identifiers to appropriate clusters. The calculation involves computing a distance metric between extracted features and a representative feature vector of each cluster of recipients, where assigning includes selecting the cluster of recipients having a minimum distance. The system computes the value of a chosen distance metric between the vector of extracted features and a representative feature vector which is typically the cluster centroid (mean of all feature vectors of destination endpoint identifiers assigned to that cluster) of each cluster of recipients. The distance metric can be, e.g., Euclidean distance, Manhattan distance, cosine similarity, or another distance measure. For example, using Euclidean distance, the system may calculate the square root of the sum of squared differences between corresponding feature values in the extracted feature vector and the cluster's representative feature vector. The system compares the calculated distance for each cluster and selects the cluster with the minimum distance as the assigned cluster.

The system implements channel selection based on cluster-specific channel preference rankings. Each cluster of recipients has an associated channel preference ranking that is derived from historical delivery success rates and recipient engagement rates of destination endpoint identifiers in that cluster. Recipient engagement rates represent how frequently recipients in a cluster interact with messages sent via different channels. For instance, one cluster may show high engagement rates with email messages (frequently opening emails and clicking links) while showing low engagement with SMS messages, while another cluster may demonstrate the opposite pattern. The system derives channel preference ranking for each cluster of recipients by analyzing the historical delivery success rates and recipient engagement rates for each channel across all destination endpoint identifiers in that cluster. For example, the system may calculate an aggregate delivery success rate for each channel (e.g., average delivery ratio across all endpoints in the cluster) and an aggregate engagement rate for each channel (e.g., average engagement rate across all endpoints in the cluster). The system then generates a combined score for each channel, such as by computing a weighted average of the delivery success rate and engagement rate (e.g., 0.7 times delivery rate plus 0.3 times engagement rate), and orders the channels from highest score to lowest score to create the channel preference ranking. The system may use a multi-criteria ranking approach where channels are primarily ranked by delivery success rate and secondarily by engagement rate (or vice versa) to resolve ties. In some embodiments, the system may perform tie-breaking using secondary criteria: (1) message volume (e.g., higher volume preferred), (2) recency of last successful delivery (e.g., more recent preferred), and (3) channel reliability score based on historical uptime data. The system may maintain separate rankings for different message types (e.g., marketing, transactional, alerts) with type-specific weighting parameters.

The channel preference ranking includes an ordered list of the plurality of communication channels ranked from highest preference to lowest preference for each cluster of recipients, where selecting the communication channel includes selecting a highest-ranked communication channel from the ordered list that is available for transmission to the destination endpoint identifier. In some embodiments, the plurality of communication channels may include at least three of: SMS, RCS, MMS, instant messaging, or email channels, and the channel preference ranking can indicate different communication channels for different clusters of recipients based on respective historical messaging patterns of destination endpoint identifiers in each cluster of recipients. In some embodiments, the system may select the communication channel from the channel preference ranking and cause the message to be transmitted via the selected channel.

When selecting among multiple destination endpoint identifiers associated with the recipient for the selected communication channel, the system may apply one or more selection criteria. For example, if multiple phone numbers are available for SMS delivery, the system may select the phone number with the highest historical delivery success rate for SMS messages, or the phone number most recently used for communication with the recipient, or the phone number designated as ‘primary’ in the recipient profile. In some embodiments, the system may select the destination endpoint identifier that belongs to the cluster of recipients with the highest preference ranking for the selected channel. In other embodiments, the client may specify a preferred destination endpoint identifier for each recipient and channel combination through configuration settings or API parameters.

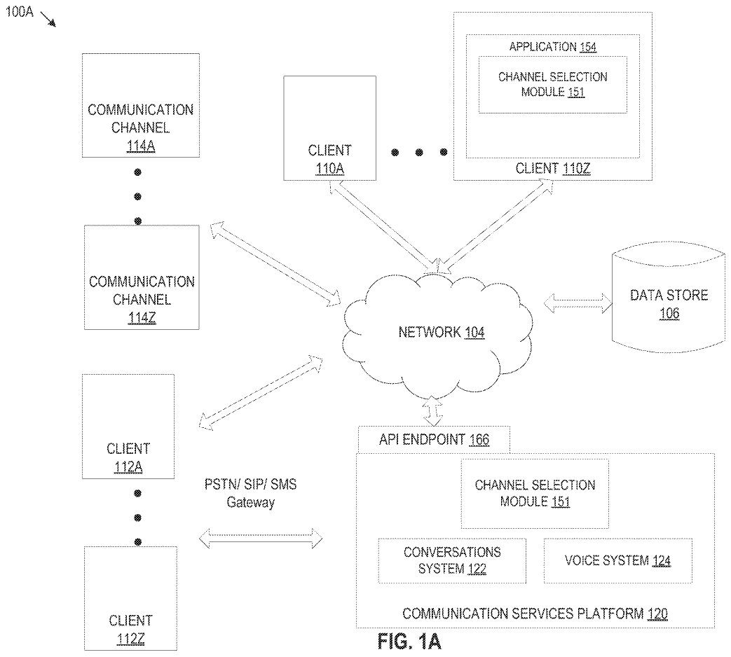

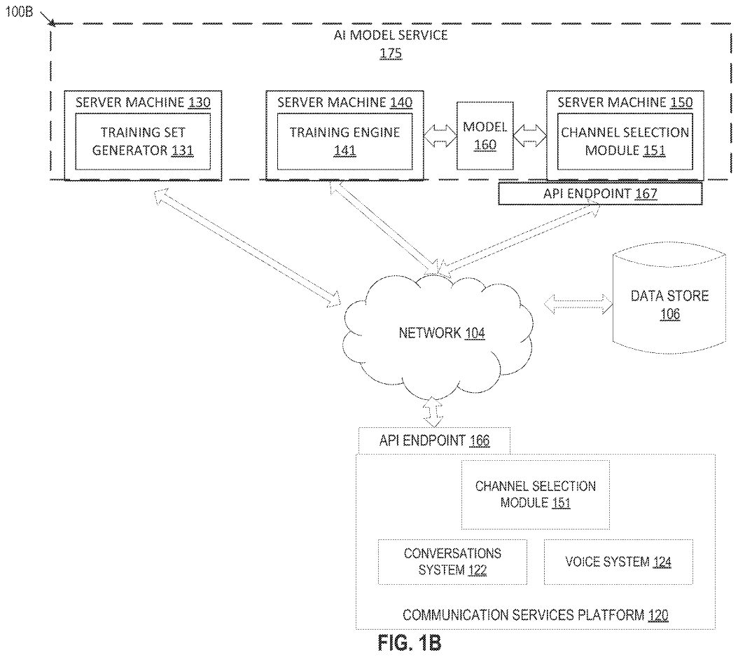

FIG. 1A illustrates an example system architecture 100A, in accordance with some embodiments of the disclosure. The system architecture 100A (also referred to as “system” herein) includes a communication services platform 120, a data store 106, client devices 110A-110Z connected to a network 104, client devices 112A-112Z communicatively coupled to communication services platform 120, and communication channels 114A-114Z coupled to the network 104 (or otherwise communicatively coupled to other elements of the system 100A).

In embodiments, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 106 is a persistent storage that is capable of storing data as well as data structures to tag, organize, and index the data. Data store 106 may be hosted by one or more storage devices, such as main memory, magnetic or optical storage based disks, tapes or hard drives, NAS, SAN, and so forth. In some embodiments, data store 106 may be a network-attached file server, while in other embodiments data store 106 may be some other type of persistent storage such as an object-oriented database, a relational database, and so forth, that may be hosted by communication services platform 120 or one or more different machines coupled to the communication services platform 120 via the network 104.

In some embodiments, data store 106 implements a relational database schema with tables such as a recipients table (e.g., a table with columns [recipient identifier, created date, last updated]), a destination endpoints table (e.g., a table with columns [endpoint identifier, recipient identifier, endpoint type, endpoint value, is active]), a messages table (e.g., a table with columns [message identifier, recipient identifier, endpoint identifier, channel identifier, sent timestamp, delivery status, content hash]), an engagements table (e.g., a table with columns [engagement identifier, message identifier, engagement type, timestamp, metadata]), and a clusters table (e.g., table with columns [cluster identifier, centroid vector, member count, last updated]). The database may support horizontal scaling through sharding based on recipient identifier hash values and implement read replicas for query performance optimization. Data retention policies may archive messages older than a predetermined time (e.g., 2 years) while preserving aggregated metrics for clustering analysis.

The client devices 110A-110Z (generally referred to as “client device(s) 110” herein) may each include a type of computing device such as a desktop personal computer (PC), laptop computer, mobile phone, tablet computer, netbook computer, wearable device (e.g., smart watch, smart glasses, etc.) network-connected television, smart appliance (e.g., video doorbell), any type of mobile device, etc. In some embodiments, client devices 110 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some embodiments, client devices 110A through 110Z may also be referred to as “user devices.”

In some embodiments, a client device, such as client device 110Z, can implement or include one or more applications, such as application 154 (also referred to as “client application 154” herein) executed at client device 110Z. In some embodiments, application 154 can be used to communicate (e.g., send and receive information) with communication services platform 120. In some embodiments, application 154 can implement user interfaces (e.g., graphical user interfaces (GUIs)) that may be webpages rendered by a web browser and displayed on the client device 110Z in a web browser window. In another embodiment, the user interfaces of client application 154 may be included in a stand-alone application downloaded to the client device 110Z and natively running on the client device 110Z (also referred to as a “native application” or “native client application” herein).

In some embodiments, client devices 110 can communicate with communication services platform 120 using one or more function calls, such as application programming interface (API) function calls (also referred to as “API calls” herein). For example, the one or more function calls can be identified in a request using one or more application layer protocols, such as HyperText Transfer Protocol (HTTP) (or HTTP secure (HTTPS)), and that are sent to the communication services platform 120 from the client device 110Z implementing application 154. In some embodiments, the communication services platform 120 can respond to the requests from the client device 110Z by using one or more API responses using an application layer protocol. Similarly, communication services platform 120 can communicate with one or more communication channels 114A-114Z using API function calls.

In some embodiments, one or more of client devices 110 can be identified by a uniform resource identifier (URI), such as a uniform resource locator (URL). For example, communication services platform 120 can send an API call to client device 110Z addressed to a URL specific to the client device 110Z. In some embodiments, the communication services platform 120 can be identified by a URI. For instance, the API call sent by a client device 110 to communication services platform 120 can be directed to the URL of communication services platform 120.

In some embodiments, the APIs used to access the conversations system 122 of the communication services platform 120 can be different from the APIs used to access the voice system 124 of communication services platform 120. In some embodiments, the APIs used by application 154 executed on a desktop client device (e.g., desktop application) to access the voice system 124 can be different APIs than the APIs used by application 154 executed on a mobile client device (e.g., mobile application) to access the voice system 124. In some embodiments, conversations system 122 and voice system 124 can communicate between one another using APIs. In some embodiments, the APIs used to communicate between conversations system 122 and voice system 124 may be private APIs that are not accessible by client devices 110 (or client devices 112).

In some embodiments, client devices 112A-112Z (generally referred to as “client device(s) 112” herein) may be similar to client devices 110. In some embodiments, client devices 112 can include one or more telephony devices. A telephony device can include a Public Switched Telephone Network (PSTN)-connected device, such as a landline phone, cellular phone, or satellite phone, for example. In some embodiments, a telephony device can also include an internet addressable voice device (e.g., non-PSTN telephony device), such as Voice-Over-Internet-Protocol (VOIP) phones, or Session Initiation Protocol (SIP) devices, for example. In some embodiments, a telephony device can include one or more messaging devices, such as a Short Message Service (SMS) network device that, for example, uses a cellular service to exchange SMS messages or Multimedia Messaging Service (MMS) messages.

In some embodiments, the communication services platform 120 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that may be used to provide a user with access to data or services. Such computing devices may be positioned in a single location or may be distributed among many different geographical locations. For example, communication services platform 120 may include a plurality of computing devices that together may include a hosted computing resource, a grid computing resource or any other distributed computing arrangement. In some embodiments, communication services platform 120 may correspond to an elastic computing resource where the allotted capacity of processing, network, storage, or other computing-related resources may vary over time.

In some embodiments, communication services platform 120 provides one or more API endpoints 166 that can expose services, functionality or content of the communication services platform 120 to one or more of client devices 110 or communication channels 114A-114Z. In some embodiments, an API endpoint 166 can be one end of a communication channel, where the other end can be another system, such as a client device 110Z or communication channel 114Z. In some embodiments, the API endpoint 166 can include or be accessed using a resource locator, such as a universal resource locator (URL), of a server or service. The API endpoint 166 can receive requests from other systems, and in some cases, return a response with information responsive to the request. In some embodiments, HTTP or HTTPS methods can be used to communicate to and from API endpoint 166.

In some embodiments, the API endpoint 166 (also referred to as a “request interface” herein) can function as a computer interface through which communication requests, such as message and/or voice requests, are received and/or created. The communication services platform 120 may include one or more types of API endpoints.

In some embodiments, the API endpoint 166 can include a messaging API and/or voice API whereby external entities or systems can send a communication to create message content and/or request sending of a message and/or request voice services that are provided via voice system 124. The API (e.g., message API and/or voice API) may be used in programmatically creating message content and/or requesting sending of one or more messages and/or requesting the transfer or joining client device(s) to a voice call. In some embodiments, the API is implemented in connection with a multitenant communication service wherein different accounts (e.g., authenticated entities) can submit independent requests. These requests made through the API can be managed with consideration of other requests made within an account and/or across multiple accounts on the communication service.

In some embodiments, the API of the API endpoint 166 may be used in initiating general messaging or communication requests. For example, a messaging request may indicate one or more destination endpoints (e.g., recipient phone numbers), message content (e.g., text and/or media content), and possibly an origin endpoint (e.g., a phone number to use as the “sending” phone number).

In some embodiments, the API of the API endpoint 166 may be any suitable type of API such as a REST (Representational State Transfer) API, a GraphQL API, a SOAP (Simple Object Access Protocol) API, and/or any suitable type of API. In some embodiments, the communication services platform 120 can expose through the API, a set of API resources which when addressed may be used for requesting different actions, inspecting state or data, and/or otherwise interacting with the communication platform.

In some embodiments, a REST API and/or another type of API may work according to an application layer request and response model. An application layer request and response model may use HTTP (Hypertext Transfer Protocol), HTTPS (Hypertext Transfer Protocol Secure), SPDY, or any suitable application layer protocol. Herein HTTP-based protocol is described for purposes of illustration rather than limitation. The disclosure should not be interpreted as being limited to the HTTP protocol. HTTP requests (or any suitable request communication) to the communication services platform 120 may observe the principles of a RESTful design or the protocol of the type of API. RESTful is understood in this document to describe a Representational State Transfer architecture. The RESTful HTTP requests may be stateless, thus each message communicated contains all necessary information for processing the request and generating a response. The API service can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some embodiments, the API endpoint 166 can include a request processing module that can be invoked within an application, script, or other computer instruction execution to handle message transmission requests. For example, a computing platform may support the execution of a set of program instructions where at least one instruction within a script or other application logic is used in specifying a message request and communicating that request.

In some embodiments, the API endpoint 166 can include a console, administrator interface, or other suitable type of user interface. Such a user-facing interface can be a graphical user interface. Such a user interface may additionally work in connection with a programmatic interface.

In some embodiments, a message transmission request initiated by a client device can include a data object characterizing the properties of a message, where the communication services platform 120 fulfills the request by transmitting the message via a selected communication channel. In some embodiments, the communication services platform 120 is associated with message requests that are programmatically initiated (e.g., an application-to-person (A2P) message). In some embodiments, the message transmission request can be initiated automatically by the communication services platform 120 in response to receiving an inbound message that triggers an automated response.

In some embodiments, a message transmission request can specify one or more destination endpoint identifiers, one or more origin endpoint identifiers, and message content. In some embodiments, a voice call request can specify one or more destination endpoint identifiers, one or more origin endpoint identifiers, and audio content for voice communication. In some embodiments, one or more of these properties may be specified indirectly through predefined system configuration settings, account-level default values, or by referencing a messaging conversation identifier that contains the required endpoint and content information. For example, all messages may be automatically assigned an origin endpoint that is associated with an account. In some embodiments, the message content can include any suitable type of media content including text, audio, image data, video data, multimedia, interactive media, data, and/or any suitable type of message content.

In an illustrative example, communication services platform 120 can include a Software as a Service (SaaS) platform that can provide one or more services, such as communication services, to one or more clients. The SaaS platform may deploy services, such as software applications, to one or more clients for use as an on-demand service. For example, the SaaS platform may deliver software applications on a subscription basis while also hosting, at least in part, the software application. The licensed software applications can, at least in part, be hosted on the infrastructure, such as the cloud computing resources of the SaaS platform.

In some embodiments, communication services platform 120 can provide communication services that include voice services, messaging services (e.g., SMS services or MMS services), email services, video services, chat messaging services (e.g., internet-based chat messaging services), or a combination thereof. Communication operations using the communication services can use one or more of a communication network (e.g., Internet), telecommunications network (e.g., such as a cellular network, satellite communication network, or landline communication network), or a combination thereof, to transfer communication data between parties.

In some embodiments, the conversations system 122 can function to interface with one or more communication network(s) and/or service(s) for communication of a conversation (e.g., a messaging conversation, such as SMS, MMS, and/or chat messaging). In some embodiments, the conversations system 122 can include an interface to one or more carrier-based communication routes used in sending SMS, MMS, and/or other carrier-based messages. There may be multiple carrier-based communication routes that serve as different optional “routes” when sending communications over a carrier-based network (e.g., a mobile network). The conversations system 122 may additionally or alternatively include an interface to one or more over-the-top (OTT) communication channels which may be offered by a third-party messaging platform (e.g., proprietary social media messaging, messaging applications, etc.).

A route can refer to a communication delivery path, defined by a series of one or more of computers, routers, gateways and/or carrier networks through which the communication is transferred from a source computer to a destination computer (e.g., through which the transmission of a message occurs). For example, the same route may be used to transfer messages using different communication channels, and the same communication channel may be used to transfer messages using different routes. In some example embodiments, different channels correspond to different applications on a receiving device. For example, a smart phone may have one application to handle SMS messages, another application to handle email, and a third application to handle voicemail. Alternatively, some applications may handle multiple communication channels. For example, one application may handle both SMS and MMS messages.

In some embodiments, when the conversations system 122 elects to send a message using a carrier-based channel, the message is communicated to an appropriate carrier connection for routing to the destination endpoint. Carrier-based channels can use SMPP (Short Message Peer-to-Peer protocol) for communicating to an aggregator or another suitable gateway such that the SMS/MMS message is transferred over a carrier network. Once transmitted to the carrier network, the message can be relayed appropriately to arrive at the intended destination. A message in transit may have multiple routing segments that are used in the delivery to an end destination device.

For example, the conversations system 122 can include an interface to one or more SMS Gateways that enable a computer to send and receive SMS text messages to and from an SMS capable device over the global telecommunications network (normally to a mobile phone). The SMS Gateway translates the message sent and makes it compatible for delivery over the network to be able to reach the recipient. The different SMS gateways (or more generally message gateways) can serve as different route options when the conversations system 122 is determining a channel and/or route to be used for one or more message transmissions.

In some embodiments, SMS Gateways can route SMS text messages to the telecommunication networks via an SMPP interface that networks expose, either directly or via an aggregator that sells messages to multiple networks. SMPP, or Short Message Peer-to-Peer, is a protocol for exchanging SMS messages between Short Message Service Centers (SMSCs) and/or External Short Messaging Entities (ESMEs).

In some embodiments, the destination of a message may be used in determining the candidate message routes (and/or channels). For example, a destination endpoint identifier associated with the intended recipient of the message (e.g., a phone number) may be used to identify the destination network of the destination endpoint. A destination network may be assigned a Mobile Country Code (MCC)/Mobile Network Code (MNC) pair that identifies the destination network.

In some embodiments, communication services platform 120 includes a conversations system 122 that can use the phone number associated with the intended recipient of the message to lookup the MCC/MNC pair identifying the destination network. For example, the conversations system 122 can determine the MCC/MNC pair using an MCC/MNC directory that lists the MCC/MNC pair corresponding to each phone number. In some embodiments, the MCC/MNC directory may be stored in a routing provider storage. Alternatively, the MCC/MNC directory may be stored at some other network accessible location. In either case, the conversations system 122 can use the phone number associated with the intended recipient of the message to query the MCC/MNC directory and identify the MCC/MNC pair that identify the corresponding destination network.

In some embodiments, the conversations system 122 can use the MCC/MNC pair retrieved from the MCC/MNC directory to identify candidate routing providers and routes that are available to deliver a message to the destination network identified by MCC/MNC pair. For example, the routing provider storage may include a routing provider directory that lists each MCC/MNC pair serviced by the conversations system 122 and the corresponding routing providers and routes available for use with each MCC/MNC pair. That is, the routing provider directory can list the routing providers and routes that are available to the conversations system 122 to deliver messages to the destination network identified by each MCC/MNC pair listed in the routing provider directory.

In some embodiments, voice system 124 of communication services platform 120 can enable the placement of an outbound voice call and/or routing of an inbound voice call. A voice call (also referred to as a “call” herein) can refer to a telephone call between at least two user devices to communicate two-way voice data (e.g., voice sound) in real-time. An outbound voice call can refer to a voice call from a client device 110 associated with an account (e.g., one or more of an organization's account or user account) of the communication services platform 120, and to another device that may not be associated with an account. An inbound voice call can refer to a voice call from a device that may not be associated with an account, and to a client device 110 associated with an account. A voice call between two client devices 110 that are associated with an account can be performed using communication services platform 120. Such voice calls can be considered inbound or outbound voice calls relative to the particular client device 110.

In some embodiments, voice system 124 can include one or more voice services used in conjunction with a voice call. In some embodiments, the one or more voice services can include a transcription service that transcribes speech to text. In some embodiments, the one or more voice services can include a recording service that can record the audio data of the voice call. In some embodiments, the one or more voice services can include a voice call queue service that can queue inbound voice calls and release the queued voice call pursuant to user-defined logic. In some embodiment, the one or more voice services can include voice mailbox services that store voice messages of at least inbound calls. In some embodiments, the one or more voice services can include an interactive voice response (IVR) service that interacts with callers and gathers information for them by giving the callers choices via a menu, and then performs the actions based on the answers of the caller through the telephone keypad or through voice response. For example, the IVR service can allow a caller to interact with the back-end telephony system, such as voice system 124, by pressing keys that emit dual-tone multi-frequency (DTMF) signals or saying words that are processed by a speech recognition system. In some embodiments, the one or more voice services can include conference call service that can connect three or more devices in a single call.

In some embodiments, communication services platform 120 can include a multitenant system as shown in FIG. 1A, where multiple client organizations can access the platform's resources through logically isolated tenant instances. Multitenancy can refer to a mode of operation of software applications where multiple independent instances of one or multiple applications operate in a shared computer environment. In some embodiments, the instances (tenants) can be logically isolated, but physically integrated. The degree of logical isolation can be complete, but the degree of physical integration can vary. The tenants can be logically isolated data and processing environments that represent different client organizations that obtain access to the multitenant system, where each tenant corresponds to a client organization but may share underlying application instances and infrastructure resources. The tenants may also be multiple applications competing for shared underlying resources. Multiple organizations can access the resources of communication services platform 120 without any indication that the resources are shared between the multiple organizations. The data of each of the organizations can be logically isolated from one another such that each organization has access to their own data but not the data of other organizations in the multitenant system. In some embodiments, communication services platform 120 can include a single tenant system.

An organization refers to a client entity, such as a legal entity, that includes multiple people and that has a particular purpose. An example of an organization includes a corporation (e.g., authorized by law to act as a single entity or legal entity). In some embodiments, multiple organizations can include one or more organizations that are independent or distinct from the other organizations. For example, a first organization can be corporation A and a second organization can be corporation B. Corporation A can be considered an independent legal entity from corporation B. Each of corporation A and corporation B can make independent decisions and have a different legal or corporate structure.

In some embodiments, a “user” may be represented as a single individual. However, other embodiments of the disclosure encompass a “user” being an entity controlled by a set of users and/or an automated source. For example, a set of individual users federated as one or more departments in an organization may be considered a “user.” In general, functions described in one embodiment as being performed by the communication services platform 120 can also be performed on the client devices 110A through 110Z in other embodiments (and vice versa), if appropriate. In addition, the functionality attributed to a particular component can be performed by different or multiple components operating together. The communication services platform 120 can also be accessed as a service provided to other systems or devices through appropriate APIs.

In some embodiments, communication channels 114A-114Z can refer to third-party entities that provide communication services integrated with communication services platform 120, where each communication channel uses a particular protocol or underlying technology for message transmission as described above. A third party can refer to an entity, such as organization or business (e.g., a different legal entity than communication services platform 120) that is distinct from another entity, such as the entity controlling or owning the communication services platform 120. In some embodiments, the communication services provided by third-party communication channels 114A-114Z can be integrated into communication services platform 120. In some embodiments, the communication services offered by communication channels 114A-114Z can include messaging services. In some embodiments, messaging services can include one or more of a short messaging service (SMS) offered by an SMS channel, a multimedia messaging service (MMS) offered by an MMS channel, or an instant messaging service (e.g., chat messaging) offered by an instant messaging service channel. In some embodiments, communication channels 114A-114Z can also include a voice channel. For example, the voice channel may implement an application to send or receive calls. In another example, the voice channel may include a telecommunication service provider and/or PSTN voice services.

In some embodiments, communication services platform 120 and/or client devices 110 include an instance of channel selection module 151. In some embodiments, channel selection module 151 of client device 110Z, of communication services platform 120, or a combination thereof can perform one or more aspects of the disclosure.

In some embodiments, an entity (e.g., organization) can be associated with an account (e.g., organizational account) of communication services platform 120. Within the particular account (e.g., organizational account) of the organization, one or more user accounts of the communication services platform 120 may be associated with different users of the organization. In some embodiments, the accounts are organized in a hierarchical structure where the organizational account is the root at the top of the hierarchy and the user accounts are nested under the organizational account.

In some embodiments, communication services platform 120 can provision endpoint identifiers (e.g., telephone numbers, such as 10-digit long code or short code) to an organization's account and assign the telephone numbers to various user accounts associated with the organization. The assignment of telephone numbers can be flexible such that the assignment of a telephone number can be one to one (e.g., one telephone number to one user account) or one to many (e.g., one telephone number to many user accounts).

In some embodiments, communication services platform 120 can dynamically assign or transfer the telephone numbers. For example, user account A may be assigned telephone number A. Telephone number A can be transferred and assigned to another user account Z and unassigned from user account A, or can be assigned to user account Z and user account A, for instance.

In some embodiments, voice calls and messages can be dynamically routed or sent to and from different telephone numbers. For instance, a user account A may be assigned telephone number A. Telephone number A may have an area code corresponding to Texas. User account A, via application 154 of client device 110A, sends, via communication services platform 120, a message A to an end user device. The end user device can be associated with a telephone number with an area code associated with the state of California. Communication services platform 120 can associate a telephone number with a California area code to the message conversation and send message A to end user device from the associated telephone number with a California area code. From the perspective of the end user device, the message A can appear to be sent from the telephone number with a California area code, rather than from the telephone number A with a Texas area code.

In some embodiments, the telephone number of the client device 110 (e.g., telephone number assigned to the client device 110 by the telecommunications carrier) can be different than the telephone number that is assigned to the user account associated with the client device 110. In some embodiments, the client device 110 may not have a telephone number assigned by a telecommunications carrier. For instance, the client device 110A may be a desktop computer. In some embodiments, the client device 110A can be identified by an internet protocol (IP) address and can send messages of the message conversation using a protocol such as HTTP over TCP/IP (transmission control protocol) or can place a voice call using a Voice over IP (VoIP) protocol (e.g. SIP) via application 154, for example.

In some embodiments, the communication services platform 120 may operate as a multi-component system that receives message transmission requests via API endpoint 166, processes recipient data through channel selection module 151, and coordinates message delivery through selected communication channels 114A-114Z. The platform may receive as input, message transmission requests containing recipient identifiers and message content, historical messaging data from data store 106, and API responses from communication channels. The platform may process this input by extracting features from historical data, applying clustering algorithms to group recipients, and selecting optimal channels based on cluster-specific preference rankings. The platform may produce as output, channel selection decisions, formatted messages for transmission, and delivery confirmations. Alternative implementations may include distributed processing across multiple servers, cloud-based deployment, or edge computing configurations.

Although embodiments of the disclosure are discussed in terms of communication service platforms, embodiments may also be generally applied to any type of platform, system or service.

In situations in which the systems discussed here collect personal information about users, or may make use of personal information, the users may be provided with an opportunity to control whether the communication services platform 120 collects user information, or to control whether and/or how to receive content from the communication services platform 120 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the communication services platform 120.

FIG. 1B illustrates an example system architecture 100B, in accordance with some embodiments of the disclosure. The system architecture 100B (also referred to as “system” herein) includes a communication services platform 120, a data store 106, server machine 130, server machine 140, and server machine 150 coupled to the network 104 (or otherwise communicatively coupled to other elements of the system 100B). One or more components of system 100A and 100B can be combined in some embodiments.

In some embodiments, an artificial intelligence (AI) model (e.g., also referred to as an “machine learning model” herein) can include a discriminative AI model (also referred to as “discriminative machine learning model” herein), a generative AI model (also referred to as “generative machine learning model” herein), and/or other AI model.

In some embodiments, a discriminative AI model can model a conditional probability of an output for given input(s). A discriminative AI model can learn the boundaries between different classes of data to make predictions on new data. In some embodiments, a discriminative AI model can include a classification model that is designed for classification tasks, such as learning decision boundaries between different classes of data and classifying input data into a particular classification. Examples of discriminative AI models include, but are not limited to, support vector machines (SVM) and neural networks.

In some embodiments, a generative AI model learns how the input training data is generated and can generate new data. A generative AI model can model the probability distribution (e.g., joint probability distribution) of a dataset and generate new samples that often resemble the training data. Generative AI models can be used for tasks involving image generation, text generation and/or data synthesis. Generative AI models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

Training of and inference using discriminative AI models (e.g., machine learning models) is described herein. Server machine 130 includes a training set generator 131 that is capable of generating training data (e.g., a set of training inputs and a set of target outputs) to train a model 160 (e.g., a discriminative AI model). In some embodiments, training set generator 131 can generate the training data based on various data (e.g., stored at data store 106 or another data store connected to the system 100B via the network 104). The data store 106 can store metadata associated with the training data. In some embodiments, generative AI model 170 can be trained in a distributed manner (e.g., server machines 140 in a distributed environment) using an internet-scale corpse of data.

Server machine 140 includes a training engine 141 that is capable of training a model 160 using the training data from training set generator 131. The model 160 (also referred to “machine learning model” or “artificial intelligence (AI) model” herein) may refer to the model artifact that is created by the training engine 141 using the training data that includes training inputs (e.g., features) and corresponding target outputs (correct answers for respective training inputs)(e.g., labels). The training engine 141 may find patterns in the training data that map the training input to the target output (the answer to be predicted) and provide the model 160 that captures these patterns. The model 160 may be composed of, e.g., a single level of linear or non-linear operations (e.g., a support vector machine (SVM), or may be a deep network, i.e., an AI model that is composed of multiple levels of non-linear operations). An example of a deep network is a neural network with one or more hidden layers, and such AI model may be trained by, for example, adjusting weights of a neural network in accordance with a backpropagation learning algorithm or the like. Model 160 can use one or more of a support vector machine (SVM), Radial Basis Function (RBF), clustering, supervised AI, semi-supervised AI, unsupervised AI, k-nearest neighbor algorithm (k-NN), linear regression, random forest, neural network (e.g., artificial neural network), a boosted decision forest, etc. For convenience rather than limitation, the remainder of this disclosure describing discriminative AI model will refer to the implementation as a neural network, even though some implementations might employ other type of learning machine instead of, or in addition to, a neural network.

In some embodiments, such as with a supervised AI model, the one or more training inputs of the set of the training inputs are paired with respective one or more training outputs of the set of training outputs. The training input-output pair(s) can be used as input to the AI model to help train the AI model to determine, for example, patterns in the data. The model parameters (e.g., values thereof) can be adjusted based on the training.

In some embodiments, training data, such as training input and/or training output, and/or input data to a trained AI model (collectively referred to as “AI model data” herein) can be preprocessed before providing the aforementioned data to the (trained or untrained) AI model (e.g., discriminative AI model and/or generative AI model) for execution. Preprocessing as applied to AI models (e.g., discriminative AI model and/or generative AI model) can refer to the preparation and/or transformation of AI model data.

In some embodiments, preprocessing can include data scaling. Data scaling can include a process of transforming numerical features in raw AI model data such that the preprocessed AI model data has a similar scale or range. For example, Min-Max scaling (Normalization) and/or Z-score normalization (Standardization) can be used to scale the raw AI model. For instance, if the raw AI model data includes feature representing temperatures in Fahrenheit, the raw AI model data can be scaled to a range of [0, 1] using Min-Max scaling.

In some embodiments, preprocessing can include data encoding. Encoding data can include a process of converting categorical or text data into a numerical format on which a AI model can efficiently execute. Categorical data (e.g., qualitative data) can refer to a type of data that represents categories and can be used to group items or observations into distinct, non-numeric classes or levels. Categorical data can describe qualities or characteristics that can be divided into distinct categories, but often does not have a natural numerical meaning. For example, colors such as red, green, and blue can be considered categorical data (e.g., nominal categorical data with no inherent ranking). In another example, “small,” “medium,” and “large” can be considered categorical data (ordinal categorical data with an inherent ranking or order). An example of encoding can include encoding a size feature with categories [“small,” “medium,” “large”] by assigning 0 to “small,” 1 to “medium,” and 2 to “large.”

In some embodiments, preprocessing can include data embedding. Data embedding can include an operation of representing original data in a different space, often of reduced dimensionality (e.g., dimensionality reduction), while preserving relevant information and patterns of the original data (e.g., lower-dimensional representation of higher-dimensional data). The data embedding operation can transform the original data so that the embedding data retains relevant characteristics of the original data and is more amenable for analysis and processing by AI models. In some embodiments embedding data can represent original data (e.g., word, phrase, document, or entity) as a vector in vector space, such as continuous vector space. Each element (e.g., dimension) of the vector can correspond to a feature or property of the original data (e.g., object). In some embodiments, the size of the embedding vector (e.g., embedding dimension) can be adjusted during model training. In some embodiments, the embedding dimension can be fixed to help facilitate analysis and processing of data by AI models.

In some embodiments, the training set is obtained from server machine 130. Server machine 150 includes a benefits module 151 that provides current data (e.g., customer data, etc.) as input to the trained AI model (e.g., model 160) and runs the trained AI model (e.g., model 160) on the input to obtain one or more outputs.

In some embodiments, confidence data can include or indicate a level of confidence of that a particular output (e.g., output(s)) corresponds to one or more inputs of the AI model (e.g., trained AI model). In one example, the level of confidence is a real number between 0 and 1 inclusive, where 0 indicates no confidence that output(s) corresponds to a particular one or more inputs and 1 indicates absolute confidence that the output(s) corresponds to a particular one or more inputs. In some embodiments, confidence data can be associated with inference using an AI model.

In some embodiments, an AI model, such as model 160, may be (or may correspond to) one or more computer programs executed by processor(s) of server machine 140 and/or server machine 150. In other embodiments, an AI model may be (or may correspond to) one or more computer programs executed across a number or combination of server machines. For example, in some embodiments, AI models may be hosted on the cloud, while in other embodiments, these AI models may be hosted and perform operations using the hardware of a client device 111. In some embodiments, the AI models may be a self-hosted AI model, while in other embodiments, AI models may be external AI models accessed by an API.

In some embodiments, server machines 130 through 150 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to one or more data items of the communication services platform 120. The communication services platform 120 can also include a website (e.g., a webpage) or application back-end software that can be used to provide users with access to the communication services platform 120.

In some embodiments, one or more of server machine 130, server machine 140, model 160, server machine 150 can be part of communication services platform 120. In other embodiments, one or more of server machine 130, server machine 140, server machine 150, or model 160 can be separate from communication services platform 120 (e.g., provided by a third-party service provider).

In some embodiments, one or more of server machine 140, server machine 150, and model 160 can be part of AI model service 175. AI model service 175 can provide AI services via API endpoint 167. For example, communication services platform 120 can request AI services from AI model service 175 such as access to one or more AI models, such as model 170 via API endpoint 167. In some embodiments, AI model service 175 is a third-party service. In other embodiments, AI model service 175 is a first-party service.

In some embodiments, any element, such as server machine 140, server machine 150, and/or data store 106 may include a corresponding API endpoint for communicating with APIs. For example and embodiments, communication services platform 120 can implement a third-party service that hosts an AI model, such as model 160, and associated services. Communication services platform 120 can access the services corresponding to the model 160 via API endpoint 167. A third-party can refer to an entity, such as an enterprise or organization (e.g., third-party SaaS service provider) that is distinct and/or external from a first-party entity, such as the communication services platform 120.

Also as noted above, for purpose of illustration, rather than limitation, aspects of the disclosure describe the training of an AI model (e.g., model 160) and use of a trained AI model (e.g., model 160). In other embodiments, a heuristic model or rule-based model can be used as an alternative. It should be noted that in some other embodiments, one or more of the functions of communication services platform 120 can be provided by a greater number of machines. For example, training of a model 160 can be performed on a distributed system of server machines. In addition, the functionality attributed to a particular component of the communication services platform 120 can be performed by different or multiple components operating together.

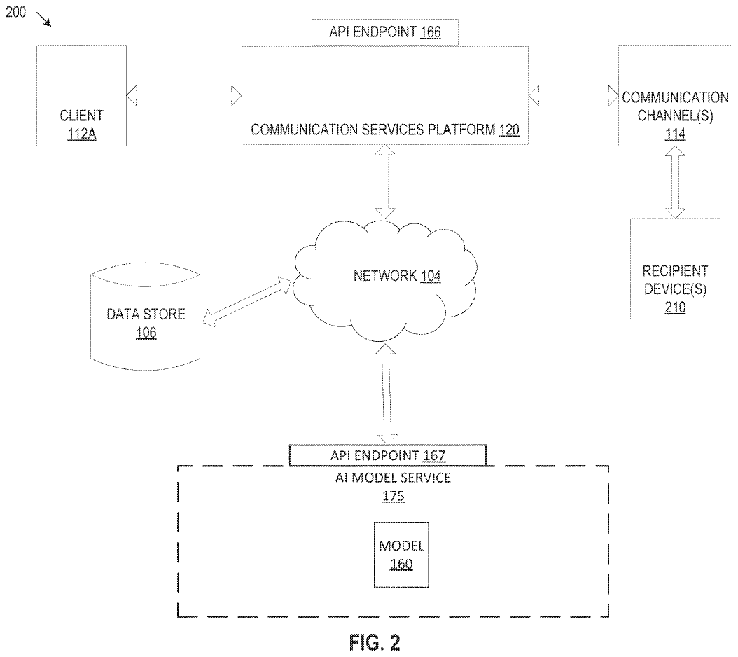

FIG. 2 illustrates an example system architecture, in accordance with some embodiments. System architecture 200 (also referred to as “system” herein) includes components as described with respect to system 100A and 100B. The description of shared components applies equally to system 200 unless otherwise advised. Additionally system 200 includes recipient device 210. Recipient device 210 can be similar to client device 112A, and the corresponding description can apply to recipient device 210, unless otherwise described.

In some embodiments, client device 112A can be sent to communication services platform 120 via an API call a request to send one or more messages to one or more recipient endpoint identifiers. In some embodiments, communication services platform 120 can determine optimal channel(s) to send the messages by extracting features from historical messaging data, associating recipients with clusters of recipients based on the extracted features, and selecting communication channels based on channel preference rankings associated with the clusters of recipients. The channel can be personalized for each particular recipient based on their associated destination endpoint identifiers, in some embodiments.

In some embodiments, communication services platform 120 can provide input data to AI model service 175. The input data can be in part retrieved from data store 106, in some embodiments. In some embodiments, the input data is used as input to an AI model, such as model 160. In some embodiments, model 160 can generate an output identifying one or more of channel score or channel ranking. In some embodiments, the model 160 can provide one or more of a channel score, a send time score (e.g., indicating a time to send the message), a telephone number score (e.g., indicating an optimal number for a recipient), among other scores/outputs as described herein.

In some embodiments, the AI model service 175 can send the output information to communication services platform 120. The input data to model 160 can include features extracted from historical messaging data, such as message volume metrics and channel-specific delivery metrics for each destination endpoint identifier and communication channel. The output information can include channel preference rankings that indicate an ordering of communication channels based on historical delivery success rates and recipient engagement rates. Using the channel preference rankings, communication services platform 120 can determine on which channel(s) to send the messages to each respective destination endpoint identifier (each corresponding to a recipient device 210). The communication services platform 120 can send the messages via the respective communication channels 114 to recipient device(s) 210.

As noted above, various AI models can be implemented for channel personalization including channel scoring and channel ranking.

In some embodiments, the training inputs of the AI model 160 can include metadata extracted from historical messaging data stored by the communication services platform 120. In some embodiments, the metadata can include one or more identifiers of channels used for the communication, error patterns such as delivery failure codes and retry attempts, deliverability rates defined as the proportion of messages successfully delivered via each communication channel, and identification of top senders based on message volume metrics, where a metadata item associated with a given message includes destination endpoint identifier, communication channel identifier, delivery timestamp, delivery success indicator, and recipient engagement events. In some embodiments, the training inputs can include message content if the client has provided explicit privacy permission through API configuration settings to include message text and media content in the training data. In some embodiments, the training inputs can include identifiers of user interaction with the message including one or more or reading the message, clicking on a corresponding resource locator (e.g., URL) in the message, purchasing an item described in the message or associated with the sender (e.g., client). In some embodiments, the training input can include the end user telephone number and/or other unique identifier such as email address, device identifier, IP address, among others.

In some embodiments, the AI model 160 is a supervised machine learning model and the training inputs for the supervised machine learning model include the total number of messages received across all channels by a destination endpoint identifier during a specified time period (e.g., last 7 days, last 30 days, etc.), where the training data includes binary labels indicating successful recipient engagement (label=1) or failed engagement (label=0) for each channel-recipient pair, and the model training minimizes a cross-entropy loss function to optimize channel preference predictions for clusters of recipients. In some embodiments, the training inputs can include an indication of the total number of unique accounts from which the telephone number receives messages during a time period (e.g., last 7 days, last 30 days, etc.). In some embodiments, the training inputs can include an indication of the total number of distinct channels from which the phone number has received messages during a time period (e.g., last 7 days, last 30 days, etc.). In some embodiments, the training inputs can include an indication of the total number of messages received on a particular channel (e.g., SMS, IM, RCS) during a time period (e.g., last 7 days, last 30 days, etc.). In some embodiments, the training inputs can include an indication a delivery ratio of overall messages during a time period (e.g., last 7 days, last 30 days, etc.). In some embodiments, the training inputs can include an indication a delivery ratio of messages for a particular channel (e.g. SMS, IM, RCS) during a time period (e.g., last 7 days, last 30 days, etc.). In some embodiments, the training inputs can include an indication a maximum of normalized split of messages across different accounts. In some embodiments, the training inputs can include an indication a medium of normalized split of messages across different accounts. In some embodiments, the training inputs can include an indication of messages from accounts classified as a particular type of account (e.g., technology account) during a time period (e.g., last 7 days, last 30 days, etc.).

In some embodiments, the training inputs can include an indication of a total number of unique phone numbers from which the number receives messages during a time period (e.g., last 7 days, last 30 days, etc.). In some embodiments, the training inputs can include an indication of a total number of segments to the telephone number sent during a time period (e.g., last 7 days, last 30 days, etc.). In some embodiments, the training inputs can include the country the telephone number is registered. In some embodiments, the training inputs can include an indication of the country that has sent the most message traffic to the telephone number during a time period (e.g., last 7 days, last 30 days, etc.).

In some embodiments, the training inputs can include an identifier of the country code of the telephone number. In some embodiments, the training inputs can include a mobile network code of the telephone number. In some embodiments, the training inputs can include a risk score (e.g., mobile country code (mcc)-mobile network code (mnc) risk score) associated with the telephone number. In some embodiments, the training inputs can include an indication of an average time that messages to the telephone number stay in a queue during a time period (e.g., last 7 days, last 30 days, etc.). In some embodiments, the training inputs can include an indication of the average time that messages to the telephone number get delivered during a time period (e.g., last 7 days, last 30 days, etc.). In some embodiments, the training inputs can include an indication of a number of messages to a telephone number that triggered a particular error code (e.g., 30007 error code) during a time period (e.g., last 7 days, last 30 days, etc.).

In some embodiments, the training inputs can include an identifier of the type of phone number and/or the category of the phone number. In some embodiments, the training inputs can include an indication of the number of messages to a telephone number that received an opt out during a time period (e.g., last 7 days, last 30 days, etc.). In some embodiments, the training inputs can include an indication of an average delay for messages on a particular channel (e.g., RCS, IM, etc.) during a time period (e.g., last 7 days, last 30 days, etc.). In some embodiments, the training inputs can include an indication of the most available used case during a time period (e.g., last 7 days, last 30 days, etc.).

In some embodiments, the training output can include a ranked list of channels for a particular telephone number. In some embodiments, the training output can include a score per channel that indicates a level of the end user's preference with respect the particular channel.

In some embodiments, channel scoring can refer to the process of assigning a score (or a rating) to each channel for a cluster of recipients based on historical delivery success rates and recipient engagement rates. A scoring function implemented by the communication services platform 120 can be used to determine the relevancy of each channel to the recipient based on the recipient's cluster assignment and associated channel preference ranking, where channels with higher scores are considered to be more preferred by recipients and the scoring function is applied during the channel selection process when transmitting messages to destination endpoint identifiers. In some embodiments, the scoring function can be designed to capture recipient preferences and produce accurate predictions of the likelihood that a recipient will engage with messages sent via a particular channel, where engagement includes opening messages, clicking links, replying to messages, or completing transactions prompted by the message. In some embodiments, the objective function can be based on one or more factors such as historical messaging data that includes message volume metrics, channel-specific delivery metrics, and recipient engagement metrics for each destination endpoint identifier. In some embodiments, the objective function can be based on one or more factors such as historical messaging data that includes message volume metrics, channel-specific delivery metrics, and recipient engagement metrics for each destination endpoint identifier. In some embodiments, the objective function can be defined as a probability function: P(recipient i prefers channel j|historical messaging data for recipient i and channel j), where i represents a recipient (e.g., a recipient associated with destination endpoint identifiers in the data store) and j represents a communication channel from the plurality of communication channels.

In some embodiments, various supervised machine learning methods can be implemented to calculate the probability function using labeled training data that includes historical messaging data with known channel preference outcomes, where the training process minimizes a loss function such as cross-entropy loss to optimize channel preference predictions. In some embodiments, a cut-off threshold P0 can be predetermined by the communication services platform 120, where all channels with probability scores P>P0 will be included in the channel preference ranking for message transmission. In some embodiments, the ordering position of such channels within the channel preference ranking is not determined. In some embodiments, the scores are not a probability function, and can be a scalar that are interpreted as probabilities based on normalizing the scalars.

In some embodiments, channel preference ranking can provide a specific ordered list of communication channels ranked from highest preference to lowest preference for each cluster of recipients. In some embodiments, channel ranking can reflect an order of channels. In some embodiments, channel scoring assigns numerical scores to channels without establishing a specific ordering. For example, the channel scoring can produce two equally preferred channels if two channels have a likelihood of recipient engagement above the threshold, for instance, both SMS and RCS are likely to be preferred. In channel ranking for instance, SMS→RCS and RCS→SMS provides two different preferences for the same recipient.
P(recipient i prefers SMS as highest-ranked channel with RCS as second-ranked)≠P(recipient i prefers RCS as highest-ranked channel with SMS as second-ranked),
   demonstrating that channel preference rankings capture the specific ordering of communication channels.

In some embodiments, channel preference ranking can incorporate Learning to Rank (LTR) techniques that generate ordered lists of communication channels based on predicted recipient engagement rates. In some embodiments, LTR can aim at predicting the probability that a recipient will engage with a message sent via a specific communication channel, given their historical messaging data including delivery success rates and engagement rates. In some embodiments, LTR techniques can be classified into or include three categories: (i) point-wise, (ii) pair-wise, and (iii) list-wise techniques.

In some embodiments, point-wise techniques can evaluate each communication channel independently for a recipient, ignoring the rank order of other channels in the plurality of communication channels. A simple point-wise approach is to use a linear model, such as logistic regression, to score each item based on a set of features. In some embodiments, pair-wise techniques compare channels in pairs, and the goal is to learn a function that assigns a higher score to the preferred item in each pair (e.g., SMS, IM). In some embodiments, list-wise techniques treat the ranked list of items as a whole and optimize a scoring function that directly maps from the item set to a ranking score.

In some embodiments, the channel scoring and channel preference ranking techniques can be implemented by the communication services platform 120 using various machine learning approaches such as binary classification, multi-class classification, recipient clustering, collaborative filtering, graph neural networks (GNNs), and learning-to-rank approaches, as further described herein.

In some embodiments, a rule-based system can implement rules that can capture recipient preferences based on features extracted from historical messaging data, such as delivery success rates and engagement rates for each communication channel. Based on features selected from recipient profiles, rules can dictate if certain criteria are met then the channel should be selected for the recipient. In some embodiments, a rule-based approach can be beneficial in its simplicity and interpretability, is computationally inexpensive and easy to implement.

For example, the communication services platform 120 can analyze historical delivery success rates and recipient engagement rates for each destination endpoint identifier in the data store to create channel preference rankings that order communication channels such as SMS, instant messaging, and RCS based on their performance for specific clusters of recipients. This historical analysis can provide labeled training data for supervised machine learning models that predict channel preferences for clusters of recipients. Using the historical messaging data stored in the data store as the reference, the extracted features can be processed to create channel preference rankings for each cluster of recipients.

In some embodiments, binary-class classification can use a labeled dataset for a subset of recipients. The labeled training data set can include binary labels indicating whether each recipient has demonstrated preference for one or more channels based on historical engagement metrics such as message open rates, click-through rates, and response rates. In some embodiments, an independent classifier is built for each channel. For each channel model, the input is recipients'features extracted from the aforementioned training data and the output is a probability that the recipient likes/prefers the channel. In some embodiments, the binary-class classification can be implemented and tested quickly, and simple models such as logistic regression can be used. In some embodiments, the binary-class classification can be used as a baseline to compare other models. In some embodiments, the measurement of model performance can be straightforward.

In some embodiments, the communication services platform 120 can implement multi-class classification. In some embodiments, multi-class classification can include an extension of binary classification by either predicting the category of each channel (for example, rating from 1-5 stars for each channel) or predicting the winner channel among all existing channels. In some embodiments, multi-class classification can provide more resolution to the classes and values. In some embodiments, the multi-class classification can consider dependencies between channels.

For example, using the destination endpoint identifier-level ground truth data derived from historical messaging data, features can be extracted at a destination endpoint identifier level from the historical messaging data stored in the data store. After fetching features data for each of the channels, a training dataset for ML modeling (as a multi-class classification problem) can be created.

In some embodiments, the communication services platform 120 can implement multi-label/multi-class classification. In some embodiments, multi-class classification can be an extension to multi-class/multi-label classification where each recipient can be assigned to multiple channels. In some embodiments, this approach can consider that the channels are non-exclusive and there is no limit of how many channels can be assigned to each recipient. In some embodiments, the multi-label/multi-class classification approach is flexible and can provide probabilities for each channel.

In some embodiments, the communication services platform 120 can implement recipient clustering. In some embodiments, recipient clustering can define clusters of recipients. In some embodiments, a clustering algorithm can include K-Nearest Neighbors (KNN), Self-Organizing Map (SOM), Hierarchical Clustering, DBSCAN, Gaussian Mixture Models (GMM), among others. In some embodiments, the clustering algorithm can be used to cluster phone numbers based on input features. For example, given a set of features as a vector, clustering algorithm(s) puts similar phone numbers (recipient phone numbers) (there are different ways of calculating similarities) into certain clusters.

For example, to define clusters, the messaging metadata (all channels) can be used as the feature space and aggregated by recipient (to_phone_number, e.g., recipient phone number). Given a set of features as a vector, clustering algorithm(s) puts similar to_phone_numbers into certain clusters. In some instances, similarity can be limited to the input features and the to_phone_numbers preferences may not be necessarily among them. The clustering approach can work well if recipients are separable with respect to input features such that the clustering algorithms can provide well-separated clusters.

In some embodiments, the communication services platform 120 can implement clustering algorithm using a K-means clustering approach with a predetermined number of clusters (e.g., k=10 clusters; configurable from 5-50 based on data size). The algorithm may initialize cluster centroids randomly, then iteratively assign each recipient to the nearest centroid based on Euclidean distance calculation. The algorithm may converge when centroid movement is less than 0.001 or after 100 iterations maximum. Other example clustering methods include hierarchical clustering using Ward linkage or DBSCAN (e.g., using epsilon=0.5 and minimum points=10).

In some embodiments, recipient clustering can implement cluster preferences. In some embodiments, with high quality clusters, the channel preferences are extracted for each cluster. For example, the channel preference for cluster A is [IM, SMS, RBM, etc.]. In some embodiments, an assumption can be that if the recipient phone number (new or existing) belongs (or is closer) to one of the clusters/groups, the cluster's preference also applies to the recipient phone number. The assumption can be verified with statistical analysis. In some embodiments, to find cluster channel preferences, the system can identify past communication data for each cluster and find successful and/or unsuccessful messages to infer communication preferences. In some embodiments, the recipient clustering approach can use unsupervised learning.

In some embodiments, collaborative filtering can be implemented. In some embodiments, collaborative filtering can be implemented to make personalized recommendations to recipients based on the preferences and behaviors of similar recipients and/or channels. In some embodiments, instead of relying on explicit channel attributes or content, collaborative filtering can leverage recipient interaction with channels and/or feedback to generate better channel preferences. In some embodiments, collaborative filtering can assume that recipients who have shown similar behavior (i.e., traffic patterns) in the past will continue to have similar preferences in the future.

In some embodiments, collaborative filtering can include model-based collaborative filtering. Model-based collaborative filtering can be used in recommendation systems to generate personalized recommendations by building statistical or machine learning models (e.g., Matrix Factorization, Latent Factor Models, Deep Learning, etc.) based on user-item interaction data. Model-based collaborative filtering can create predictive models that capture the underlying patterns and relationships in the data. These models can make predictions for recipient-channel interactions, allowing for more efficient and scalable recommendations. Model-based collaborative filtering is a versatile approach and can be scalable making them suitable for large datasets with many users and channels. In some embodiments, model-based collaborative filtering can handle the cold start problem by making predictions for users or items with limited interaction data. In some embodiments, model-based collaborative filtering can capture complex and personalized patterns as user preferences, resulting in highly personalized recommendations. In some embodiments, model-based collaborative filtering can effectively leverage implicit feedback data (e.g., clicks, views) in addition to explicit feedback (e.g., ratings if available), which is valuable in developing recommendations.

In some embodiments, collaborative filtering can include memory-based collaborative filtering such as channel-based collaborative filtering including a channel-channel similarity matrix. In this approach, a matrix can be created where rows and columns represent a channel, and each cell contains a similarity score between pairs of items based on user interactions. In some embodiments, channel-based collaborative filtering can scale better than other approaches and can be more efficient when there are many users and items. It is also robust to the “user cold start” problem.

In some embodiments, memory-based collaborative filtering can include recipient-based collaborative filtering such as a recipient-channel interaction matrix and finding similar recipients. In some embodiments, in the recipient-channel interaction matrix approach, a matrix is created where rows represent users, columns represent items, and each cell contains user-item interaction data (e.g., ratings, purchase history, likes, or clicks).

In the finding similar recipients approach, similarity measures (e.g., cosine similarity, Pearson correlation) can be used to identify recipients who have similar interaction/traffic patterns. Users with high similarity scores are considered to have similar preferences. To make recommendations for a target recipient, the system identifies items that similar users have liked or interacted with but that the target user has not. These items are then recommended to the target user. In some embodiments, recipient-based collaborative filtering can be relatively easy to implement and can provide serendipitous recommendations by discovering items liked by similar users.

In some embodiments, graph neural networks (GNNs) can be implemented. In some embodiments, in a GNN given recipients, customers, channels metadata and calculated similarities, a similarity graph (or any other graph that shows two recipients are connected somehow) can be generated. A GNN is an optimizable transformation on all attributes of the graph (nodes, edges, global-context) that preserves graph symmetries (permutation invariances). In some embodiments, node-level prediction (recipients, for example) predicts the channel preferences given the graph structure and node level data. In some embodiments, GNNs are advanced models that exhibit flexibility in working with graph data. GNNs can excel at capturing the relationships and interactions between nodes (recipients). GNNs have become more scalable to handle large graphs.

In some embodiments, a learning-to-rank (LTR) approach can be implemented by the communication services platform 120 to generate channel preference rankings for clusters of recipients. In some embodiments, the LTR can include a type of supervised machine learning problem where the goal is to train a model to produce a ranking of a set of channels based on their relevance to an input query combining recipients and context (features extracted from metadata). In some embodiments, the task is to learn a ranking function that, given a recipient data (query), can predict the correct order of channels in which they should be presented as the response to the query. Given a set of training instances (q, D, R), where q is a query (recipient and contexts), D is a set of documents (all possible solutions), and R is the corresponding relevance solutions, the goal is to learn a function f(q, D) that produces a ranking of the solutions. Recommendation systems is one of the areas that use learning to rank to prioritize items based on a user's preferences. In some embodiments, the LTR provides a ranked list of solutions. An LTR has flexibility to define the query and document. In some embodiments, the LTR is flexible in data representation with textual and categorical data.

In some embodiments, channel personalization can be implemented in conjunction with routing optimization. In some embodiments, routing optimization can be determined based on one or more factors such as cost, quality (e.g., whether a message has actually been delivered) and/or latency. In some embodiments, channel optimization can be calculated, and a particular channel can be determined, and channel personalization can be used to verify the channel selected by channel optimization. In some embodiments, channel personalization can be a factor in route optimization.

In some embodiments, after determining recipient preferences through clustering analysis, there can be different ways to incorporate these channel preference rankings into the channel selection optimization process, such as using multi-armed bandit algorithms or multi-objective optimization models that balance channel preferences with delivery cost and latency factors. In some embodiments, user personalization input can be used as a criterion. In some embodiments, assuming the optimization algorithm is to find the optimal order of channels for the given message, the solution can preserve the order of channels as determined by user's preferences. In some instances, the optimized order may not be aligned with the user's preferences. In this case, one can minimize the discordance between these ranked lists. For example, Kendall Tau (KT) and Rank-biased Overlap (RBO) are metrics that can compare two ranked lists and find how similar the orders are. KT is a scalar in [−1, 1] where 1 means the lists have the same order and −1 indicates complete disagreement in ordering channels. This metric can be an objective function to be maximized. In a multi-objectives formulation, such metrics can be considered as a criterion so the optimization algorithm takes the preferred channels into account.

In some embodiments, post-optimization modification can be implemented. In some embodiments, depending on the optimization (decision making) model, it may not be straightforward to include personalization in the optimization process. In this case, post modification can be made. For example, if the objective (loss) function doesn't significantly change, the order of channels can be updated using, for example, sensitivity analysis.

In some embodiments, various success criteria or metrics can be implemented to evaluate the machine learning models. In some embodiments, the success criteria can depend on models and what outputs the model provides. In some embodiments, success criteria or metrics can include accuracy metrics. In some embodiments, for models that provide channel scoring such as binary classification, multi-call classification, multi-label classification, etc. the system can use typical/modified classification metrics such as precision, recall and/or F1-score (e.g., accuracy metrics). In some embodiments, precision explains how many of the correctly predicted cases actually turned out to be positive. Precision can be useful in cases where false positives are a higher concern than false negatives. In some embodiments, recall explains how many of the actual positive cases the system is able to predict correctly with the model. Recall can be a useful metric in cases where false negatives are of higher concern than false positives, such as in medical cases. In some embodiments, the F1-score gives a combined idea about precision and recall metrics. The F1-score is maximum when precision is equal to recall.

In some embodiments, the success criteria or metrics can include clustering metrics. Unlike classification models, in unsupervised learning samples are not labeled, making it a relatively complex task to perform and evaluate. In some embodiments, the clustering metrics can include one or more of the silhouette score, Rand index, mutual information, or Calinski-Harabasz index. In some embodiments, the silhouette score and silhouette plot are used to measure the separation distance between clusters. It displays a measure of how close each point in a cluster is to points in the neighboring clusters. In some embodiments, the Rand index computes a similarity measure between two clusters by considering all pairs of samples and counting pairs that are assigned in the same or different clusters in the predicted and true clustering. In some embodiments, the mutual information is a measure of the similarity between two labels of the same data. In some embodiments. Calinski-Harabasz Index is also known as the variance ratio criterion. The score is defined as the ratio between the within-cluster dispersion and the between-cluster dispersion. The C-H Index does not require information on the ground truth labels.

In some embodiments, success criteria or metrics can include ranking metrics. Ranking metrics can include one or more of mean reciprocal rank (MRR), normalized discounted cumulative gain (NDCG), and precision at K. In some embodiments, MRR measures the quality of the highest-ranked relevant product. It is calculated as the reciprocal of the rank of the first relevant product. Higher MRR values indicate that relevant products are ranked higher in the recommendation list. In some embodiments, NDCG evaluates the ranking quality of the recommendation list by assigning higher scores to relevant products that are ranked higher. It considers the position of each relevant product in the list and discounts products that are ranked lower. In some embodiments, precision at K measures the precision of the top K recommendations. It calculates the proportion of relevant products among the top K recommended channels.

In some embodiments, channel selection can be based on one or more of message classification and recipient classification. In some embodiments, message classification can refer to classifying a message as a certain type of message, where the type of message is based on the content of the message. For example, the message type can include a marketing message, a one-time password message, an alert and so forth. In some embodiments, the message type can be more granular. For instance, the marketing message can be for shoes (e.g., shoe type marketing message, for dining (e.g., dining type marketing message), and so forth. In some embodiments, the training data for the message classification machine learning model can include training inputs including message metadata, such as recipient phone number, channel, send time, response time (e.g., engagement), and so forth. Other training inputs as described herein can be used. In some embodiments, the training inputs can include the content of the messages. The training output can include a label, such as a message type.

In some embodiments, the recipient classification model can classify a recipient as a particular type of recipient. In some embodiments, the communication services platform 120 may not have a profile that contains recipient data that is provided by the recipient. Rather the communication services platform 120 can use messages and engagement of a recipient with messages to infer characteristics of a recipient. For example, if the recipient engages with messages that discuss men's health issues as well as makes purchases of children's shoes, the communication services platform 120 can infer that the recipient is male with one or more children.

In some embodiments, the recipient classification model can be based on message type and engagement with the message of the particular message type. Engagement can include, for example, opening the message, selecting a resource locator (e.g., link), making a transaction (e.g., sale) and so forth. In some embodiments, the training input to the recipient classification model can include an identifier of the type of message (e.g., obtained from the message classification model) and an indication of the type of user engagement (or non-engagement) with the message. In some embodiments, training inputs can include metadata such as time the message was sent, time engagement occurred, and so forth (e.g., other training inputs as described herein). The training output can include a label indicating recipient type (e.g., male that is over 40 with children). From the recipient type, the communication services platform 120 can infer characteristics about the recipient. In some embodiments, the recipient type can be part of the cluster that can be associated with certain characteristics. The characteristics can include or be associated with one or more of optimal channel, optimal time to send messages, optimal telephone number to which the message is to be sent, and which people are included in the cluster. In some embodiments, the characteristics can interplay with one another. For instance, for a particular channel, the optimal time may be different than for another channel.

In some embodiments, the recipient classification model can be used to determine the one or more of optimal channel, optimal time to send messages, optimal telephone number to which the message is to be sent, and which people are included in the cluster. In some embodiments, the recipient classification model can be used to determine, for a particular message type, which recipient should be sent the message and/or which recipients should not be sent a message. In some embodiments, the recipient classification model can classify recipients of a particular tenant of a multi-tenant system.

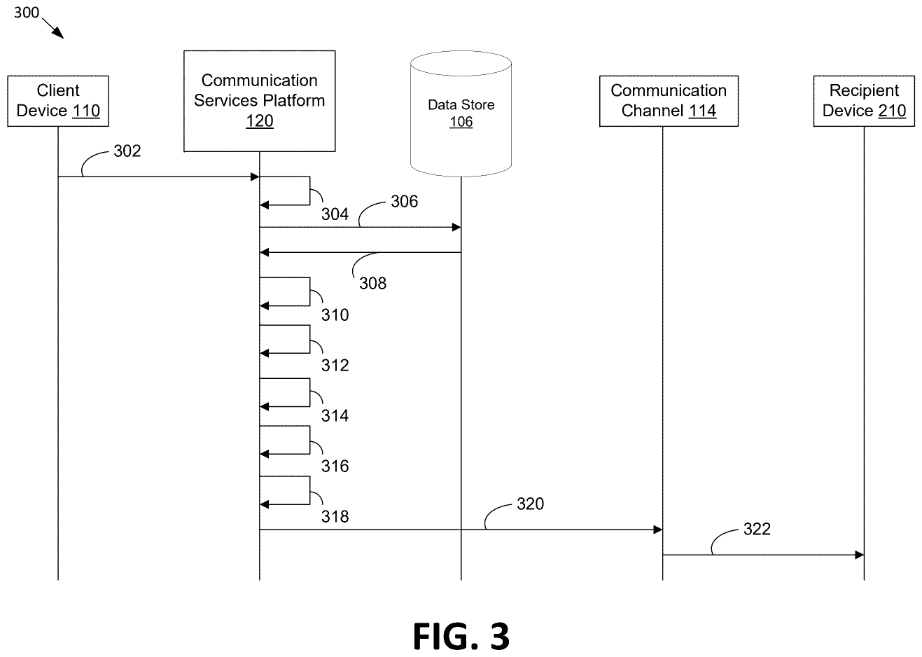

FIG. 3 illustrates a time sequence diagram 300 for channel selection and personalization process, in accordance with some embodiments of the disclosure. The time sequence diagram 300 shows the interaction between client device 110, communication services platform 120, data store 106, communication channel 114, and recipient device 210, as described with reference to FIGS. 1A, 1B, and 2. The sequence may begin at event 302 when client device 110 initiates a request to transmit a message to a recipient by sending the request to communication services platform 120. Communication services platform 120 may process the request through a series of internal operations and external data retrieval steps, culminating in message delivery to recipient device 210 at event 322. The timing of events 302-322 may occur sequentially (or in parallel as and when input data for processing becomes available), with some operations such as feature extraction (event 310), clustering (event 312), and channel selection (events 316-318) occurring as internal processing steps within the communication services platform 120. Events 306 and 308 represent the data retrieval interaction with data store 106, which may occur in parallel with or prior to the clustering operations depending on system implementation. The transmission events 320 and 322 represent the actual message delivery through the selected communication channel 114 to recipient device 210.

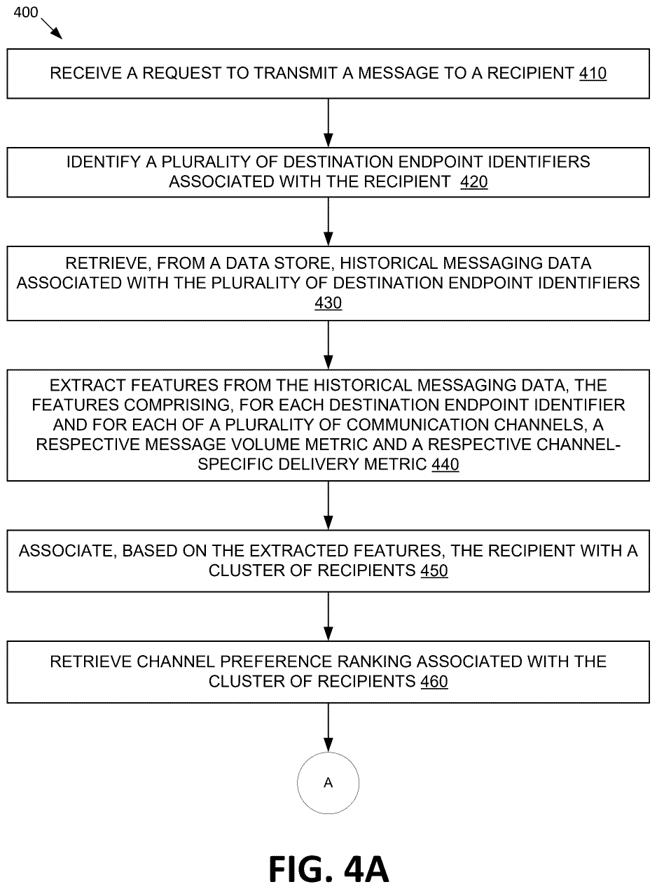

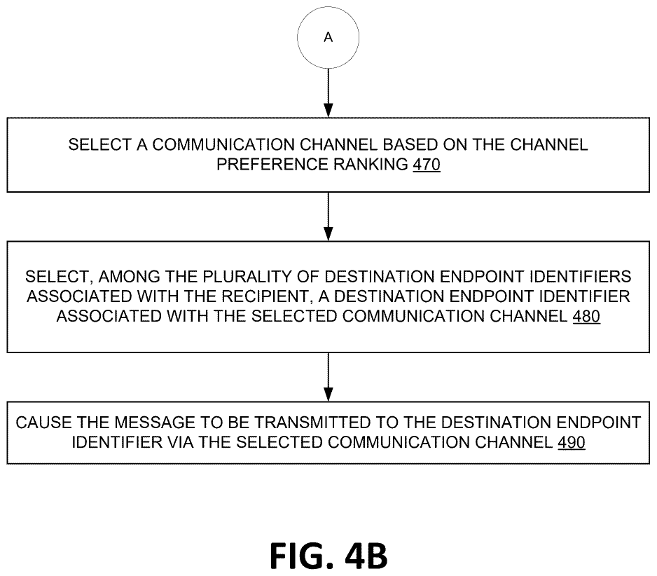

FIGS. 4A and 4B show a flow diagram of an example method 400 of channel selection and personalization based on machine learning models, in accordance with aspects of the present disclosure. The method 400 can be used for implementing intelligent channel selection by clustering recipients based on their messaging behavior patterns and selecting optimal communication channels based on cluster-specific channel preference rankings. The method 400 illustrates the decision-making process that occurs when the communication services platform receives a message transmission request and determines the most appropriate channel and destination endpoint identifier for message delivery. The method 400 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the channel selection module 151 of communication services platform 120 of FIGS. 1A, 1B, and 2. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other process flows are possible.

Referring to FIG. 4A, at block 410, the communication services platform 120 can receive a request to transmit a message to a recipient. The request may be initiated by client device 110 through API endpoint 166, as shown in FIGS. 1A and 1B. The request includes message content and recipient information that enables the communication services platform 120 to begin the channel selection process.

At block 420, the communication services platform 120 can identify a plurality of destination endpoint identifiers associated with the recipient. In some embodiments, the communication services platform 120 may access a recipient profile database that stores mappings between recipient identifiers and their associated destination endpoint identifiers. In some embodiments, the communication services platform 120 may identify destination endpoint identifiers including phone numbers for SMS messages, email addresses for promotional emails, and messaging application identifiers for customer service interactions. In some embodiments, the communication services platform 120 may receive the mapping of recipients to destination endpoint identifiers through an API call or configuration data provided by the client.

At block 430, the communication services platform 120 can retrieve, from data store 106, historical messaging data associated with the plurality of destination endpoint identifiers. The historical messaging data can include stored records of past message deliveries, such as individual message delivery information, aggregated delivery statistics, engagement event data, delivery success indicators, failure codes, timestamps, and recipient interaction events across different communication channels, as described with reference to FIGS. 1A and 2.

At block 440, the communication services platform 120 can extract features from the historical messaging data, the features including, for each destination endpoint identifier and for each of a plurality of communication channels, a respective message volume metric, a respective channel-specific delivery metric, and/or a respective recipient engagement metric. In some embodiments, the communication services platform 120 may extract features that may include a total number of messages received by the destination endpoint identifier during a time period, for each communication channel of the plurality of communication channels, a channel-specific message count indicating a number of messages received via that communication channel during the time period, for each communication channel of the plurality of communication channels, a channel-specific delivery metric indicating a proportion of messages successfully delivered via that communication channel, and a recipient engagement metric indicating a rate at which the recipient associated with the destination endpoint identifier engaged with received messages. In some embodiments, the communication services platform 120 may calculate the message volume metric as an aggregate across all communication channels or as channel-specific message counts. In some embodiments, the communication services platform 120 may represent absent data as zero values, null values, or may omit those feature dimensions entirely from the feature vector.

At block 450, the communication services platform 120 can associate, based on the extracted features, the recipient with a cluster of recipients. In some embodiments, the communication services platform 120 may calculate similarity measures between extracted features for each destination endpoint identifier and a plurality of clusters of recipients. Each cluster of recipients may include destination endpoint identifiers having similar messaging patterns, and assign each destination endpoint identifier to a respective cluster of recipients. In some embodiments, the communication services platform 120 may aggregate the extracted features across the plurality of destination endpoint identifiers to generate a recipient feature profile, calculate a similarity measure between the recipient feature profile and a plurality of clusters of recipients, and assign the recipient to a cluster of recipients based on the similarity measure. In some embodiments, the communication services platform 120 may compute a distance metric between the extracted features for each destination endpoint identifier and a representative feature vector of each cluster of recipients of a plurality of clusters of recipients, and select the cluster of recipients having a minimum distance. In some embodiments, the communication services platform 120 may use distance metrics including Euclidean distance, Manhattan distance, cosine similarity, or another distance measure.

At block 460, the communication services platform 120 can retrieve channel preference ranking associated with the cluster of recipients. Each cluster of recipients may have an associated channel preference ranking that is derived from historical delivery success rates and recipient engagement rates of destination endpoint identifiers in that cluster. In some embodiments, the communication services platform 120 may derive channel preference rankings where each cluster of the plurality of clusters of recipients may include destination endpoint identifiers having similar respective feature vectors, and the channel preference ranking for each cluster of recipients may be derived from aggregated message delivery outcomes for destination endpoint identifiers in that cluster of recipients. In some embodiments, the communication services platform 120 may generate channel preference rankings that indicate an ordering of the plurality of communication channels based on historical delivery success rates and recipient engagement rates for destination endpoint identifiers in the cluster of recipients.

Referring to FIG. 4B, at block 470, the communication services platform 120 can select a communication channel based on the channel preference ranking. In some embodiments, the communication services platform 120 may select a communication channel where the channel preference ranking may include an ordered list of the plurality of communication channels ranked from highest preference to lowest preference for the cluster of recipients. The communication services platform 120 may select a highest-ranked communication channel from the ordered list that is available for transmission to the destination endpoint identifier. In some embodiments, the communication services platform 120 may select from a plurality of communication channels that includes at least three of: a Short Message Service (SMS) channel, a Rich Communication Services (RCS) channel, a Multimedia Messaging Service (MMS) channel, an instant messaging channel, or an email channel, and the channel preference ranking indicates different communication channels for different clusters of recipients based on respective historical messaging patterns of destination endpoint identifiers in each cluster of recipients.

At block 480, the communication services platform 120 can select, among the plurality of destination endpoint identifiers associated with the recipient, a destination endpoint identifier associated with the selected communication channel. The communication services platform 120 may apply selection criteria to choose the most appropriate destination endpoint identifier for the selected communication channel, such as selecting the destination endpoint identifier with the highest historical delivery success rate, the most recently used identifier, or the identifier designated as primary in the recipient profile.

At block 490, the communication services platform 120 can cause the message to be transmitted to the destination endpoint identifier via the selected communication channel. The communication services platform 120 may route the message through the selected communication channel 114 to recipient device 210, as shown in FIGS. 2 and 3, completing the channel selection and personalization process.

For example, when client device 110A requests transmission of a promotional message to recipient “customer123”, the communication services platform 120 may perform the following sequence of operations: (1) identify destination endpoint identifiers [phone: +1234567890, email: customer@example.com] from recipient profile database, (2) retrieve historical messaging data showing 50 SMS messages with 90% delivery rate and 15% engagement rate, 20 emails with 95% delivery rate and 25% engagement rate over the past 30 days, (3) extract feature vector [0.70, 0.90, 0.95, 0.20, 0.8] representing [normalized volume, SMS delivery, email delivery, average engagement, recency], (4) calculate Euclidean distances to existing cluster centroids [cluster_1: distance=0.45, cluster_2: distance=0.23, cluster_3: distance=0.67] and assign to cluster_2 with minimum distance, (5) retrieve cluster_2 channel preference ranking [email: 0.87, SMS: 0.72, RCS: 0.45] based on historical cluster performance, (6) select email channel as highest-ranked available option, (7) selects customer@example. com as destination endpoint identifier, and (8) transmit message via email communication channel 114B with delivery confirmation tracking

In some embodiments, the communication services platform 120 may handle edge cases through error handling mechanisms. For example, when historical messaging data is insufficient (fewer than 5 messages), the communication services platform 120 may assign recipients to a default cluster based on demographic similarity or geographic proximity. When feature extraction fails due to corrupted data, the communication services platform 120 may apply interpolation using similar recipients'feature values or falls back to system-wide averages. When clustering algorithms fail to converge, the communication services platform 120 may revert to rule-based assignment using predefined criteria such as geographic region or message volume tiers. When no suitable cluster exists (e.g., all distances exceed similarity threshold), the communication services platform 120 may create a new cluster or assigns to the closest existing cluster with a confidence penalty. When channel preference rankings are unavailable, the communication services platform 120 may apply a default ranking based on global performance statistics across all clusters.

In some embodiments, the communication services platform 120 may operate with configurable parameters such as similarity threshold (e.g., 0.7; range 0.1-0.9, where lower values create more inclusive clusters), minimum cluster size (e.g., 10 recipients; range 5-100, adjusted based on total recipient population), engagement time window (e.g., 7 days; range 1-30 days for measuring recent engagement), feature normalization bounds (e.g., [0,1]; using min-max scaling), clustering convergence threshold (e.g., 0.001; maximum centroid movement between iterations), maximum clustering iterations (e.g., 100; prevents infinite loops), delivery success threshold (e.g., 0.8; minimum rate for channel consideration), and engagement decay factor λ (e.g., 0.1; controls time-based weighting of historical engagement data). These parameters may be adjusted through administrative interface or API configuration calls to optimize performance for different client requirements and data characteristics

Example embodiments for channel selection and personalization based on machine learning models are described herein. In one aspect, a communication services platform 120 can provide message data associated with a message to a trained machine learning model 160, as shown in FIG. 1B. The trained machine learning model 160 can be trained using training data that includes historical message metadata and channel performance metrics, where training set generator 131 generates the training data and training engine 141 trains the model 160. The communication services platform 120 can obtain from the trained machine learning model 160 an output that identifies a first channel among a plurality of channels 114A-114Z to send the message. The communication services platform 120 can cause the message to be transmitted via the first channel through routing providers 150A-N to recipient device 210, as described in reference to FIG. 2.

In some embodiments, the trained machine learning model 160 may include a binary classification model that can classify each channel of channels 114A-114Z as preferred or not preferred for a recipient associated with recipient device 210. The binary classification model can perform independent classification for each channel, enabling the communication services platform 120 to make binary preference decisions for individual channels.

In some embodiments, the trained machine learning model 160 may include a multi-class classification model that can assign each channel of channels 114A-114Z to one of a plurality of preference categories, such as rating categories from 1 to 5 stars. The multi-class classification model can enable the communication services platform 120 to provide more granular preference modeling than binary classification.

In some embodiments, the trained machine learning model 160 may include a learning-to-rank model that can generate a ranked list of the plurality of channels 114A-114Z ordered by predicted recipient engagement. The learning-to-rank model can enable the communication services platform 120 to select channels based on their position in the ranked list, with higher-ranked channels being preferred for message transmission.

In some embodiments, the training data may further include a total number of messages received by a telephone number during a time period, and the trained machine learning model 160 can use the total number of messages to predict channel preference. This can enable the communication services platform 120 to account for message volume patterns when selecting optimal channels for different recipients.

In some embodiments, the training data may further include a delivery ratio of messages for each channel during a time period, and the trained machine learning model 160 can use the delivery ratio to predict optimal channel selection. This can enable the communication services platform 120 to favor channels with higher historical delivery success rates for specific recipients.

In some embodiments, the training data may further include a mobile country code and mobile network code associated with a telephone number, and the trained machine learning model 160 can use the mobile country code and mobile network code to predict regional channel preferences. This can enable the communication services platform 120 to select channels based on geographic preferences that vary by region or country.

In some embodiments, the training data may further include error code patterns associated with message delivery attempts, and the trained machine learning model 160 can use the error code patterns to predict channel reliability. This can enable the communication services platform 120 to avoid channels that have historically generated delivery errors for specific recipients or telephone numbers.

In some embodiments, the training data may further include an average time that messages to a telephone number stay in a queue during a time period, and the trained machine learning model 160 can use the average time to predict channel latency performance. This can enable the communication services platform 120 to select faster channels for time-sensitive messages by avoiding channels with high queue times.

In some embodiments, the communication services platform 120 may classify the message into a message type category selected from marketing messages, one-time password messages, and alert messages. The communication services platform 120 can provide the message type category as input to the trained machine learning model 160, and obtaining the output can include receiving the first channel based on the message type category. This can enable the communication services platform 120 to select channels that are optimized for specific message types.

In some embodiments, the communication services platform 120 may track recipient engagement with the message after transmission via the first channel. The communication services platform 120 can apply a recipient classification model that uses the message type category and the recipient engagement as input to classify a recipient into a recipient type. The communication services platform 120 can update a recipient profile based on the recipient type, enabling improved channel selection for future messages to the same recipient.

In another aspect, the communication services platform 120 can receive recipient data associated with a recipient, as described in reference to FIG. 2. The communication services platform 120 can apply a recipient clustering algorithm to the recipient data to assign the recipient to a cluster of recipients. The communication services platform 120 can determine a preferred channel ranking for the recipient based on communication patterns of recipients in the cluster. The communication services platform 120 can select a communication channel from a plurality of communication channels based on the preferred channel ranking.

In some embodiments, the recipient clustering algorithm may include a K-Nearest Neighbors algorithm that can identify recipients with similar communication behaviors. The K-Nearest Neighbors algorithm can enable the communication services platform 120 to group recipients based on similarity metrics calculated from their communication patterns.

In some embodiments, the recipient clustering algorithm may include a Self-Organizing Map algorithm that can create topological representations of recipient communication patterns. The Self-Organizing Map algorithm can enable the communication services platform 120 to visualize and cluster recipients based on neural network-generated topology maps.

In some embodiments, the recipient clustering algorithm may include a Gaussian Mixture Model that can model probability distributions of recipient communication patterns. The Gaussian Mixture Model can enable the communication services platform 120 to perform probabilistic clustering based on statistical distributions of recipient behaviors.

In some embodiments, the communication services platform 120 may analyze successful message delivery patterns for recipients in the cluster and can rank the plurality of communication channels based on delivery success rates for the cluster. This can enable the communication services platform 120 to apply cluster-wide performance statistics to individual recipients within the cluster.

In some embodiments, the recipient data may include message traffic patterns indicating frequency of messages received per channel, and the communication services platform 120 can apply the recipient clustering algorithm using the message traffic patterns to determine cluster assignment. This can enable the communication services platform 120 to group recipients based on their message volume and frequency characteristics across different channels.

In some embodiments, the communication services platform 120 may apply collaborative filtering to identify recipients with similar channel usage patterns. The communication services platform 120 can generate channel recommendations based on preferences of the similar recipients and can modify the preferred channel ranking based on the channel recommendations. This can enable the communication services platform 120 to leverage recommendation system techniques for channel selection.

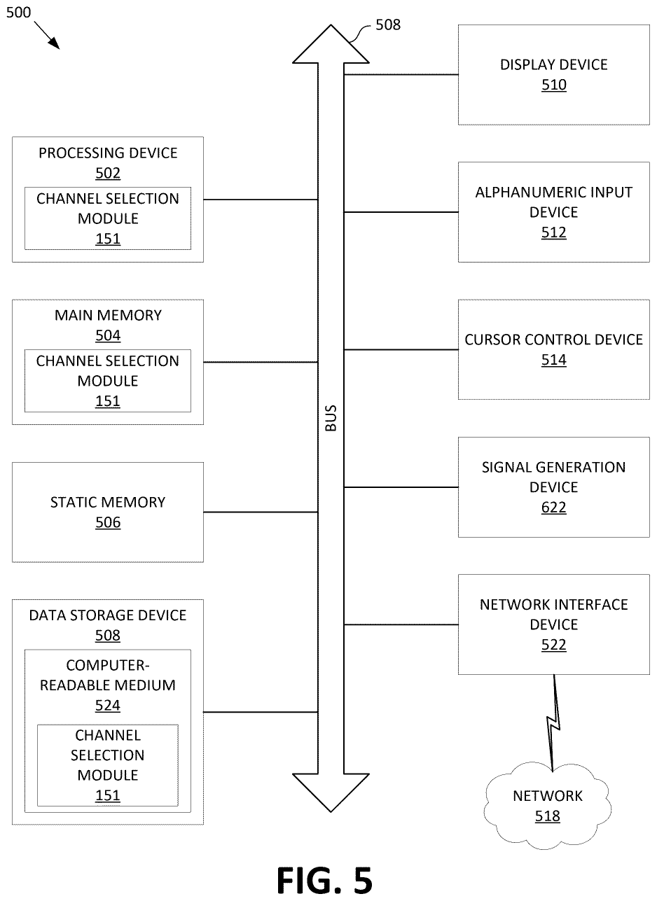

In another aspect, the processing device 302 can train a machine learning model using training data that includes message metadata and channel performance metrics, as shown in FIG. 5. The processing device 302 can receive recipient data associated with a target recipient and provides the recipient data to the trained machine learning model. The processing device 302 can obtain a channel selection output that includes a recommended communication channel and transmit a message via the recommended communication channel through network interface device 322.

In some embodiments, the machine learning model may include a graph neural network, and the processing device 302 can generate a similarity graph representing relationships between recipients based on communication patterns. The processing device 302 can apply the graph neural network to the similarity graph to predict channel preferences for the target recipient, enabling graph-based relationship modeling for channel selection decisions.

FIG. 5 is a block diagram illustrating an exemplary computer system 500, in accordance with an embodiment of the disclosure. The computer system 500 executes one or more sets of instructions that cause the machine to perform any one or more of the methodologies discussed herein. Set of instructions, instructions, and the like may refer to instructions that, when executed by computer system 500, cause computer system 500 to perform one or more operations of channel selection module 151. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 516, which communicate with each other via a bus 508.

The processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions of the system architecture 100A/100B and channel selection module 151 for performing the operations discussed herein.

The computer system 500 may further include a network interface device 522 that provides communication with other machines over a network 518, such as a local area network (LAN), an intranet, an extranet, or the Internet. The computer system 500 also may include a display device 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a non-transitory computer-readable storage medium 524 on which is stored the sets of instructions of the system architecture 100A of channel selection module 151 embodying any one or more of the methodologies or functions described herein. The sets of instructions of the system architecture 100A/100B and of channel selection module 151 may also reside, completely or at least partially, within the main memory 504 and/or within the processing device 502 during execution thereof by the computer system 500, the main memory 504 and the processing device 502 also constituting computer-readable storage media. The sets of instructions may further be transmitted or received over the network 518 via the network interface device 522.

While the example of the computer-readable storage medium 524 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
receiving a request to transmit a message to a recipient;
identifying a plurality of destination endpoint identifiers associated with the recipient;
retrieving, from a data store, historical messaging data associated with the plurality of destination endpoint identifiers;
extracting features from the historical messaging data, the features comprising, for each destination endpoint identifier and for each of a plurality of communication channels, a respective message volume metric, a respective channel-specific delivery metric, and a respective recipient engagement metric;
associating, based on the extracted features, the recipient with a cluster of recipients;
retrieving channel preference ranking associated with the cluster of recipients;
selecting a communication channel based on the channel preference ranking;
selecting, among the plurality of destination endpoint identifiers associated with the recipient, a destination endpoint identifier associated with the selected communication channel; and
causing the message to be transmitted to the destination endpoint identifier via the selected communication channel.

2. The method of claim 1, wherein associating the recipient with a cluster of recipients comprises:
aggregating the extracted features across the plurality of destination endpoint identifiers to generate a recipient feature profile;
calculating a similarity measure between the recipient feature profile and a plurality of clusters of recipients; and
assigning the recipient to a cluster of recipients based on the similarity measure.

3. The method of claim 2, wherein each cluster of the plurality of clusters of recipients comprises destination endpoint identifiers having similar respective feature vectors, and wherein the channel preference ranking for each cluster of recipients is derived from aggregated message delivery outcomes for destination endpoint identifiers in that cluster of recipients.

4. The method of claim 2, wherein calculating the similarity measure comprises computing a distance metric between the extracted features for each destination endpoint identifier and a representative feature vector of each cluster of recipients of a plurality of clusters of recipients, and wherein assigning comprises selecting the cluster of recipients having a minimum distance.

5. The method of claim 1, wherein the channel preference ranking for the cluster of recipients indicates an ordering of the plurality of communication channels based on historical delivery success rates and recipient engagement rates for destination endpoint identifiers in the cluster of recipients.

6. The method of claim 1, wherein the features extracted from the historical messaging data comprise:
a total number of messages received by the destination endpoint identifier during a time period;
for each communication channel of the plurality of communication channels, a channel-specific message count indicating a number of messages received via that communication channel during the time period;
for each communication channel of the plurality of communication channels, a channel-specific delivery metric indicating a proportion of messages successfully delivered via that communication channel; and
a recipient engagement metric indicating a rate at which the recipient associated with the destination endpoint identifier engaged with received messages.

7. The method of claim 1, wherein the channel preference ranking comprises an ordered list of the plurality of communication channels ranked from highest preference to lowest preference for the cluster of recipients, and wherein selecting the communication channel comprises selecting a highest-ranked communication channel from the ordered list that is available for transmission to the destination endpoint identifier.

8. The method of claim 1, wherein:
the plurality of communication channels comprises at least three of: a Short Message Service (SMS) channel, a Rich Communication Services (RCS) channel, a Multimedia Messaging Service (MMS) channel, an instant messaging channel, or an email channel; and
the channel preference ranking indicates different communication channels for different clusters of recipients based on respective historical messaging patterns of destination endpoint identifiers in each cluster of recipients.

9. A system comprising:
a memory device; and
a processing device coupled to the memory device, the processing device to perform operations comprising:
receiving a request to transmit a message to a recipient;
identifying a plurality of destination endpoint identifiers associated with the recipient;
retrieving, from a data store, historical messaging data associated with the plurality of destination endpoint identifiers;
extracting features from the historical messaging data, the features comprising, for each destination endpoint identifier and for each of a plurality of communication channels, a respective message volume metric and a respective channel-specific delivery metric;
associating, based on the extracted features, the recipient with a cluster of recipients;
retrieving channel preference ranking associated with the cluster of recipients;
selecting a communication channel based on the channel preference ranking;
selecting, among the plurality of destination endpoint identifiers associated with the recipient, a destination endpoint identifier associated with the selected communication channel; and
causing the message to be transmitted to the destination endpoint identifier via the selected communication channel

10. The system of claim 9, wherein associating the recipient with a cluster of recipients comprises:
aggregating the extracted features across the plurality of destination endpoint identifiers to generate a recipient feature profile;
calculating a similarity measure between the recipient feature profile and a plurality of clusters of recipients; and
assigning the recipient to a cluster of recipients based on the similarity measure.

11. The system of claim 10, wherein each cluster of recipients of the plurality of clusters of recipients comprises destination endpoint identifiers having similar respective feature vectors, and wherein the channel preference ranking for each cluster of recipients is derived from aggregated message delivery outcomes for destination endpoint identifiers in that cluster of recipients.

12. The system of claim 10, wherein calculating the similarity measure comprises computing a distance metric between the extracted features for each destination endpoint identifier and a representative feature vector of each cluster of recipients of a plurality of clusters of recipients, and wherein assigning comprises selecting the cluster of recipients having a minimum distance.

13. The system of claim 9, wherein the channel preference ranking for the cluster of recipients indicates an ordering of the plurality of communication channels based on historical delivery success rates and recipient engagement rates for destination endpoint identifiers in the cluster of recipients.

14. The system of claim 9, wherein the features extracted from the historical messaging data comprise:
a total number of messages received by the destination endpoint identifier during a time period;
for each communication channel of the plurality of communication channels, a channel-specific message count indicating a number of messages received via that communication channel during the time period;
for each communication channel of the plurality of communication channels, a channel-specific delivery metric indicating a proportion of messages successfully delivered via that communication channel; and
a recipient engagement metric indicating a rate at which the recipient associated with the destination endpoint identifier engaged with received messages.

15. The system of claim 9, wherein the channel preference ranking comprises an ordered list of the plurality of communication channels ranked from highest preference to lowest preference for the cluster of recipients, and wherein selecting the communication channel comprises selecting a highest-ranked communication channel from the ordered list that is available for transmission to the destination endpoint identifier.

16. The system of claim 9, wherein:
the plurality of communication channels comprises at least three of: a Short Message Service (SMS) channel, a Rich Communication Services (RCS) channel, a Multimedia Messaging Service (MMS) channel, an instant messaging channel, or an email channel; and
the channel preference ranking indicates different communication channels for different clusters of recipients based on respective historical messaging patterns of destination endpoint identifiers in each cluster of recipients.

17. A non-transitory computer-readable medium comprising instructions that, when executed by a processing device, cause the processing device to perform operations comprising:
receiving a request to transmit a message to a recipient;
identifying a plurality of destination endpoint identifiers associated with the recipient;
retrieving, from a data store, historical messaging data associated with the plurality of destination endpoint identifiers;
extracting features from the historical messaging data, the features comprising, for each destination endpoint identifier and for each of a plurality of communication channels, a respective message volume metric and a respective channel-specific delivery metric;
associating, based on the extracted features, the recipient with a cluster of recipients;
retrieving channel preference ranking associated with the cluster of recipients;
selecting a communication channel based on the channel preference ranking;
selecting, among the plurality of destination endpoint identifiers associated with the recipient, a destination endpoint identifier associated with the selected communication channel; and
causing the message to be transmitted to the destination endpoint identifier via the selected communication channel.

18. The non-transitory computer-readable medium of claim 17, wherein associating the recipient with a cluster of recipients comprises:
aggregating the extracted features across the plurality of destination endpoint identifiers to generate a recipient feature profile;
calculating a similarity measure between the recipient feature profile and a plurality of clusters of recipients; and
assigning the recipient to a cluster of recipients based on the similarity measure.

19. The non-transitory computer-readable medium of claim 18, wherein each cluster of recipients of the plurality of clusters of recipients comprises destination endpoint identifiers having similar respective feature vectors, and wherein the channel preference ranking for each cluster of recipients is derived from aggregated message delivery outcomes for destination endpoint identifiers in that cluster of recipients.

20. The non-transitory computer-readable medium of claim 18, wherein calculating the similarity measure comprises computing a distance metric between the extracted features for each destination endpoint identifier and a representative feature vector of each cluster of recipients of a plurality of clusters of recipients, and wherein assigning comprises selecting the cluster of recipients having a minimum distance.
